(19) United States
(12) Patent Application Publication
(10) Pub. No.: US 2017/0021558 A1
(43) Pub. Date: Jan. 26, 2017

(54) THREE-DIMENSIONALLY SHAPED ARTICLE AND THREE-DIMENSIONALLY SHAPING METHOD

(71) Applicant: SEIKO EPSON CORPORATION, Tokyo (JP)

(72) Inventors: Takeshi MIYASHITA, Suwa-shi (JP); Tomoyuki KAMAKURA, Matsumoto-shi (JP)

(21) Appl. No.: 15/208,000

(22) Filed: Jul. 12, 2016

(30) Foreign Application Priority Data
Jul. 24, 2015 (JP) 2015-146425

(51) Int. Cl. B29C 65/16

(52) U.S. Cl. CPC B29C 65/16; B29K 2505/00

(57) ABSTRACT

A three-dimensionally shaped article is formed by stacking a second single layer on a first single layer, the first single layer including a sintered single layer obtained by irradiating a sintering target material including a metal powder and a binder with an energy beam capable of sintering the sintering target material, and the second single layer including at least the sintered single layer, wherein the sintered single layer is formed by aggregating sintered bodies each sintered by irradiating the sintering target material ejected to form a droplet shape with the energy beam, and defining a sintered body diameter in a planar view of the sintered body as Ds, a distance between sintered body centers of the sintered bodies adjacent to each other as Ps,

### BACKGROUND

1. Technical Field

The present invention relates to a three-dimensionally shaped article and a three-dimensionally shaping method.

2. Related Art

In the past, as a manufacturing method for easily and simply shaping a three-dimensionally shaped article using a metal material, there has been disclosed such a method as shown in JP-A-2008-184622. In the method of manufacturing a three-dimensionally shaped article disclosed in JP-A-2008-184622, a metal paste having metal powder, a solvent, and an adhesion enhancement agent is formed as a laminated material layer, and is used as a raw material. Further, the laminated material layer is irradiated with a light beam to form a metal sintered layer or a metal melt layer, and by repeating the formation of the material layer and the irradiation with the light beam, the sintered layers or the melt layers are stacked, and thus the desired three-dimensionally shaped article is obtained.

In the method of manufacturing a three-dimensionally shaped article of JP-A-2008-184622, in one of the material layers stacked one another and constituting the three-dimensionally shaped article, scanning with the light beam is performed using a galvanometer mirror so as to follow the irradiation path of the light beam obtained from three-dimensional CAD data or the like, and the material layer is melted and then solidified, and thus, the desired sintered layer can be obtained. Further, in the method of manufacturing a three-dimensionally shaped article of the specification of US-2014/0175706-A1, there is disclosed the fact that the drop positions of the raw material are disposed so as to be different between the first layer and the second layer, and between the second layer and the third layer.

In the method of manufacturing the three-dimensionally shaped article disclosed in JP-A-2008-184622, in order to enhance the productivity, it is required to broaden the melting and solidifying width of the material layer in a direction crossing the scanning with the light beam, or to increase the scan speed. On the other hand, in the case in which a fine shaped region is included in the three-dimensionally shaped article, by narrowing the melting and solidifying width, and decreasing the scan speed, the fine shaping can be achieved.

Further, in the method of manufacturing the three-dimensionally shaped article disclosed in US-2014/0175706-A1, although there is a proposal to separately form a second layer different from a first layer in order to correct a faulty dot ejection position, or to provide a correction to the ejection position in order to correct the height of the first layer having been formed and then shrunk, there is no proposal regarding a method of enhancing the efficiency to the highest level and making the material feed possible.

As described above, it results that an improvement in the productivity of a three-dimensionally shaped article and an improvement in the precision shaping accuracy of the fine shaped part include respective factors conflicting with each other. However, in the method of manufacturing a three-dimensionally shaped article disclosed in JP-A-2008-184622, in order to realize the increase in the productivity and the improvement in the precision shaping accuracy, it becomes necessary to provide a plurality of light beam irradiation units so as to be able to perform irradiation with, for example, a light beam with which the irradiation with the wide melting and solidifying width is achievable, and a light beam for the precision shaping, and it results that growth in size of the device or rise in device cost is incurred.

### SUMMARY

An advantage of the invention is to obtain a three-dimensionally shaped article, with which high productivity is obtained by increasing the melting and solidifying width with an energy beam emitted from a single irradiation unit for the energy beam, and at the same time, precision shaping of a fine shape is realized with high accuracy, and a method of shaping the three-dimensionally shaped article.

The invention can be implemented as the following aspects or application examples.

### Application Example 1

A three-dimensionally shaped article according to this application example is a three-dimensionally shaped article formed by stacking a second single layer on a first single layer, the first single layer including a sintered single layer obtained by irradiating a sintering target material including a metal powder and a binder with an energy beam capable of sintering the sintering target material, and the second single layer including at least the sintered single layer, wherein the sintered single layer is formed by aggregating sintered bodies each sintered by irradiating the sintering target material ejected to form a droplet shape with the energy beam, and defining a sintered body diameter in a planar view of the sintered body as Ds, and a distance between sintered body centers of the sintered bodies adjacent to each other as Ps, 0.5≦Ps/Ds<1.0 is fulfilled.

The three-dimensionally shaped article according to this application example is an article which can be obtained by stacking sintered single layers of the metal shaped article obtained by sintering a metal powder by the irradiation with the energy beam. Further, the sintered single layer is formed as an aggregate of a plurality of sintered bodies. The sintered single layer obtained in such a manner is formed while fulfilling the relationship of 0.5≦Ps/Ds<1.0 defining a sintered body diameter in a planar view of the sintered body as Ds, and a distance between sintered body centers of the sintered bodies adjacent to each other as Ps.

According to this application example, by making Ps get closer to Ds, namely by approximating Ps/Ds to 1.0 in the relationship described above, the sintered bodies adjacent to each other are disposed farther from each other. Therefore, the sintered single layer can be formed in a short time to enhance the productivity. Further, by approximating Ps/Ds to 0.5, the sintered bodies adjacent to each other are disposed closer to each other, namely so that the overlapping area increases, and therefore, the sintered single layer having the sintered bodies adjacent to each other aggregated densely can be formed to make the precision shaping possible.

It should be noted that in this application example, the term sintering in “capable of sintering” means the phenomenon that the binder constituting the sintering target material is decomposed or evaporated by the supplied energy due to the energy supplied to the sintering target material, and then the remaining metal powder causes metallic bonding due to the supplied energy. It should be noted that the configuration in which the metal powder is fusion bonded is also described as sintering in the specification on the grounds that the metal powder is bonded by supplying energy.

### Application Example 2

This application example is directed to the application example described above, in which the sintered single layer includes a first sintered body, a second sintered body, and a third sintered body adjacent to each other, and in the second single layer, the sintered body center of the sintered body included in the second single layer is disposed so as to overlap a triangular area in a planar view configured by connecting the respective sintered body centers of the first sintered body, the second sintered body, and the third sintered body included in the first single layer to each other.

In Application Example 1 described above, if the first, second, and third sintered bodies adjacent to each other in the first single layer are arranged with the distance Ps between the respective sintered body centers having a value approximate to the value of Ds, a missing part of the sintered body occurs between the sintered bodies adjacent to each other in some cases. However, according to the application example described above, by disposing the sintered body included in the second single layer so that the sintered body center overlaps the inside of the area in the planar view of the triangular area obtained by connecting the respective sintered body centers of the first, second, and third sintered bodies adjacent to each other included in the first single layer in the lower layer, and then applying the energy beam for forming the sintered body in the second single layer, the missing part of the sintered body caused in the first single layer can be filled. Thus, the three-dimensionally shaped article can be obtained while eliminating the missing part of the sintered body, in other words the area which can be a defective part, inside the three-dimensionally shaped article.

### Application Example 3

This application example is directed to the application example described above, in which the energy beam is a laser.

According to the application example described above, the control of irradiating the accurate position with the energy, and the accurate control of increasing and decreasing the energy amount can be achieved. Therefore, the three-dimensionally shaped article high in quality can be obtained while achieving high productivity.

### Application Example 4

A three-dimensionally shaping method according to this application example is a three-dimensionally shaping method adapted to obtain a three-dimensionally shaped article by stacking a second single layer on a first single layer, the first single layer including a sintered single layer obtained by irradiating a sintering target material including a metal powder and a binder with an energy beam capable of sintering the sintering target material, and the second single layer including at least the sintered single layer, wherein the sintered single layer is formed by aggregating sintered bodies each sintered by irradiating a unit material formed by ejecting the sintering target material to form a droplet shape with the energy beam, and defining a unit material diameter in a planar view of the unit material as Dm, and a distance between unit material centers of the unit materials adjacent to each other as Pm, 0.5≦Pm/Dm<1.0 is fulfilled.

The shaping method of a three-dimensionally shaped article according to this application example is a method of obtaining the article by stacking sintered single layers of the metal shaped article obtained by sintering a metal powder by the irradiation with the energy beam. Further, the sintered single layer is formed as an aggregate of a plurality of sintered bodies. The sintered single layer obtained in such a manner is formed while fulfilling the relationship of 0.5≦Pm/Dm<1.0 defining a unit material diameter in a planar view of the unit material as a raw material for forming the sintered body by the irradiation with the laser as Dm, and a distance between unit material centers adjacent to each other as Pm.

According to this application example, by making Pm get closer to Dm, namely by approximating Pm/Dm to 1.0 in the relationship described above, the unit materials to be formed as the sintered bodies adjacent to each other are disposed farther from each other. Therefore, the sintered single layer can be formed in a short time to enhance the productivity. Further, by approximating Pm/Dm to 0.5, the unit materials to be formed as the sintered bodies adjacent to each other are disposed closer to each other, namely so that the overlapping area increases, and therefore, the unit materials adjacent to each other are densely arranged, the sintered single layer, in which the sintered bodies obtained by sintering the unit materials thud arranged are aggregated densely, can be formed to make the precision shaping possible.

### Application Example 5

This application example is directed to the application example described above, in which the sintered bodies included in the sintered single layer include a first sintered body, a second sintered body, and a third sintered body adjacent to each other, and in the second single layer, the unit material center of the unit material forming the sintered body included in the second single layer overlaps a triangular area in a planar view constituted by respective sintered body centers of the first sintered body, the second sintered body, and the third sintered body included in the first single layer.

In Application Example 4 described above, if the respective unit materials to be formed as the first, second, and third sintered bodies adjacent to each other in the first single layer are arranged with the distance Pm between the respective unit material centers having a value approximate to the value of Dm, a missing part of the sintered body occurs between the sintered bodies thus formed by sintering and adjacent to each other in some cases. However, according to the application example described above, by disposing the unit material to be formed as the sintered body included in the second single layer so that the unit material center overlaps the inside of the area in the planar view of the triangular area obtained by connecting the respective sintered body centers of the first, second, and third sintered bodies adjacent to each other included in the first single layer in the lower layer, and then applying the energy beam for forming the sintered body in the second single layer, the missing part of the sintered body caused in the first single layer can be filled. Thus, the three-dimensionally shaped article can be obtained while eliminating the missing part of the sintered body, in other words the area which can be a defective part, inside the three-dimensionally shaped article.

### Application Example 6

This application example is directed to the application example described above, in which the energy beam is a laser.

According to the application example described above, the control of irradiating the accurate position with the energy, and the accurate control of increasing and decreasing the energy amount can be achieved. Therefore, the three-dimensionally shaped article high in quality can be obtained while achieving high productivity.

### BRIEF DESCRIPTION OF THE DRAWINGS

The invention will be described with reference to the accompanying drawings, wherein like numbers reference like elements.

FIG. 1 is a schematic configuration diagram showing a configuration of a three-dimensionally shaping device for manufacturing a three-dimensionally shaped article according to a first embodiment of the invention.

FIG. 2 is a side external view showing a holding unit of the three-dimensionally shaping device for manufacturing the three-dimensionally shaped article according to the first embodiment.

FIG. 3 is an external view viewed from above showing the holding unit of the three-dimensionally shaping device for manufacturing the three-dimensionally shaped article according to the first embodiment.

FIG. 4 is a schematic diagram showing formation of sintered bodies constituting a sintered single layer of the three-dimensionally shaped article according to the first embodiment.

FIG. 5 is a schematic diagram showing formation of the sintered bodies constituting the sintered single layer of the three-dimensionally shaped article according to the first embodiment.

FIG. 6 is a schematic diagram showing formation of the sintered bodies constituting the sintered single layer of the three-dimensionally shaped article according to the first embodiment.

FIG. 7 is a conceptual diagram for explaining an arrangement of the sintered bodies constituting the sintered single layer of the three-dimensionally shaped article according to the first embodiment.

FIG. 8 is a conceptual diagram for explaining the arrangement of the sintered bodies constituting the sintered single layer of the three-dimensionally shaped article according to the first embodiment.

FIG. 9 is a conceptual diagram for explaining the arrangement of the sintered bodies constituting the sintered single layer of the three-dimensionally shaped article according to the first embodiment.

FIG. 10 is a conceptual diagram for explaining the arrangement of the sintered bodies constituting the sintered single layer of the three-dimensionally shaped article according to the first embodiment.

FIG. 11 is a conceptual diagram for explaining the arrangement of the sintered bodies constituting the sintered single layer of the three-dimensionally shaped article according to the first embodiment.

FIG. 12 is a conceptual diagram for explaining the arrangement of the sintered bodies constituting the sintered single layer of the three-dimensionally shaped article according to the first embodiment.

FIG. 13 is a conceptual diagram for explaining the arrangement of the sintered bodies constituting the sintered single layer of the three-dimensionally shaped article according to the first embodiment.

FIG. 14 is a cross-sectional view of the part A-A′ shown in FIG. 9.

FIG. 15 is a flowchart showing a method of manufacturing a three-dimensionally shaped article according to a second embodiment of the invention.

FIG. 16 is a partial cross-sectional view showing a process of manufacturing the three-dimensionally shaped article according to the second embodiment.

FIG. 17 is a partial cross-sectional view showing a process of manufacturing the three-dimensionally shaped article according to the second embodiment.

FIG. 18 is a partial cross-sectional view showing a process of manufacturing the three-dimensionally shaped article according to the second embodiment.

FIG. 19 is a partial cross-sectional view showing a process of manufacturing the three-dimensionally shaped article according to the second embodiment.

FIG. 20 is a planar conceptual diagram showing an arrangement of a unit material of the three-dimensionally shaped article according to the second embodiment.

FIG. 21 is a cross-sectional view of the part B-B′ shown in FIG. 20.

FIG. 22 is a partial cross-sectional view showing a process of manufacturing the three-dimensionally shaped article according to the second embodiment.

FIG. 23 is a partial cross-sectional view showing a process of manufacturing the three-dimensionally shaped article according to the second embodiment.

FIG. 24 is a partial cross-sectional view showing a process of manufacturing the three-dimensionally shaped article according to the second embodiment.

FIG. 25 is a planar conceptual diagram showing an arrangement of a unit material of the three-dimensionally shaped article according to the second embodiment.

FIG. 26 is a partial cross-sectional view showing a process of manufacturing the three-dimensionally shaped article according to the second embodiment.

FIG. 27 is a partial cross-sectional view showing a process of manufacturing the three-dimensionally shaped article according to the second embodiment.

FIG. 28 is a partial cross-sectional view showing a process of manufacturing the three-dimensionally shaped article according to the second embodiment.

FIG. 29 is a cross-sectional view of a three-dimensionally shaped article formed by a three-dimensionally shaping method according to a third embodiment of the invention.

FIG. 30 is a flowchart showing the three-dimensionally shaping method according to the third embodiment.

FIG. 31 is a cross-sectional view showing a process according to the three-dimensionally shaping method according to the third embodiment.

FIG. 32 is a cross-sectional view showing a process according to the three-dimensionally shaping method according to the third embodiment.

FIG. 33 is a cross-sectional view showing a process according to the three-dimensionally shaping method according to the third embodiment.

FIG. 34 is a cross-sectional view showing a process according to the three-dimensionally shaping method according to the third embodiment.

### DESCRIPTION OF EXEMPLARY EMBODIMENTS

Some embodiments according to the invention will hereinafter be described with reference to the accompanying drawings.

### First Embodiment

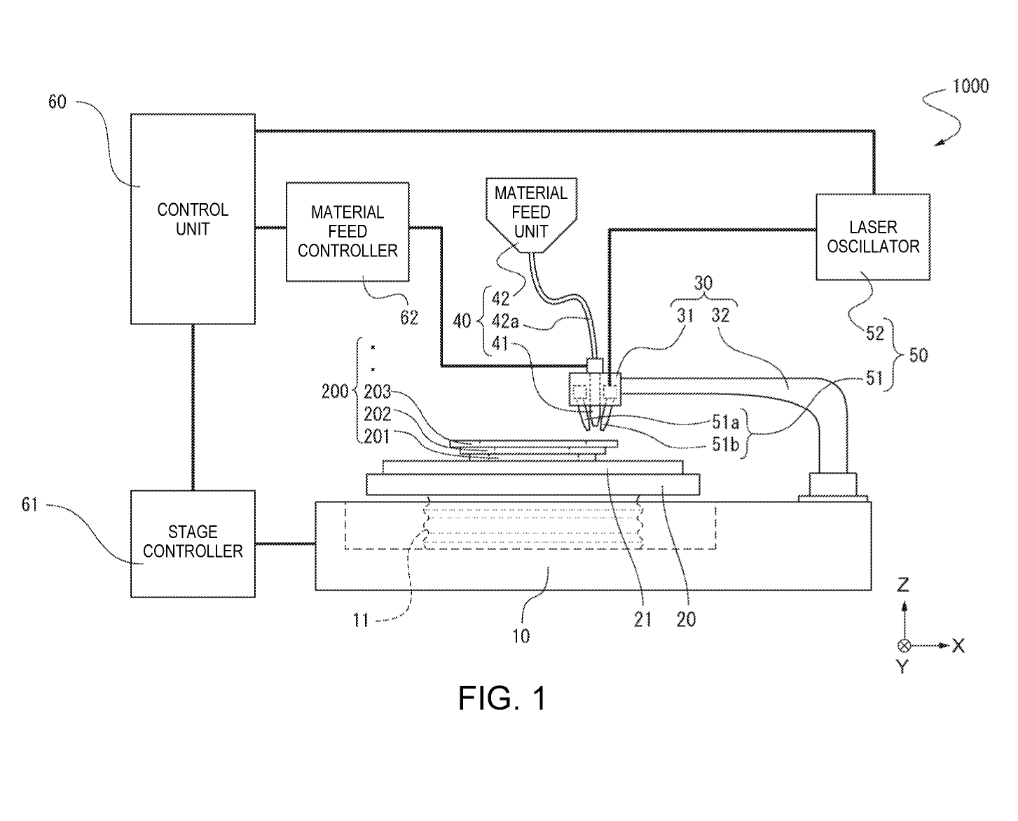

FIG. 1 is a configuration diagram showing a general configuration showing an example of a manufacturing device for shaping the three-dimensionally shaped article according to the first embodiment. It should be noted that the “three-dimensionally shaped article” in the specification represents what is formed as a so-called solid shaped article, and even a shaped article having a so-called two-dimensional shape such as a plate-like shape is included in the three-dimensionally shaped article providing the shape has a thickness.

As shown in FIG. 1, the three-dimensionally shaping device 1000 is provided with a base 10, a stage 20 provided so as to be able to be driven in the X, Y, and Z directions shown in the drawing by a drive device 11 as a drive unit provided to the base 10, and a head support part 30 provided with a support arm 32 having one end part fixed to the base 10, and the other end part for holding and fixing a head 31 as a holding unit for holding a material feed unit and an energy irradiation unit described later. It should be noted that although in the present embodiment, there is described a configuration in which the stage 20 is driven by the drive device 11 in the X, Y, and Z directions, the invention is not limited to this configuration, and it is sufficient for the stage 20 and the head 31 to be relatively driven in the X, Y, and Z directions.

Further, on the stage 20, there are formed partial shaped articles 201, 202, and 203 in a process of being shaped to the three-dimensionally shaped article 200 in a layered manner. Although described later, since the irradiation with the thermal energy using a laser is performed in shaping the three-dimensionally shaped article 200, in order to protect the stage 20 from the heat, it is possible to use a sample plate 21 having a heat resistance property, and to shape the three-dimensionally shaped article on the sample plate 21. As the sample plate 21, by using, for example, a ceramic plate, a high heat resistance property can be obtained, and further, the reactivity with the feed material to be sintered or melted is low, and thus, the transformation of the three-dimensionally shaped article can be prevented. It should be noted that although the three layers, namely the partial shaped articles 201, 202, and 203, are illustrated in FIG. 1 for the sake of convenience of explanation, stacking is performed until the desired three-dimensionally shaped article 200 is formed.

The head 31 holds a material ejection part 41 provided to a material feed device 40 as a material feed unit, and a laser irradiation part 51 as an energy irradiation part provided to a laser irradiation device 50 as an energy irradiation unit. The laser irradiation part 51 is provided with a first laser irradiation part 51a and a second laser irradiation part 51b in the present embodiment.

The three-dimensionally shaping device 1000 is provided with a control unit 60 as a control unit for controlling the stage 20 described above, the material ejection part 41 provided to the material feed device 40, and the laser irradiation device 50 based on shaping data of the three-dimensionally shaped article 200 output from a data output device such as a personal computer not shown. Although not shown in the drawings, the control unit 60 is provided with at least a drive control section of the stage 20, an operation control section of the material ejection part 41, and an operation control section of the laser irradiation device 50. Further, the control unit 60 is provided with a control section for driving and operating the stage 20, the material ejection part 41, and the laser irradiation device 50 in cooperation with each other.

Regarding the stage 20 movably provided to the base 10, signals for controlling start and stop of moving, a moving direction, a moving amount, a moving speed, and so on of the stage 20 are generated in a stage controller 61 based on control signals from the control unit 60, and then transmitted to the drive device 11 provided to the base 10, and thus, the stage 20 is moved in the X, Y, and Z directions shown in the drawings.

Regarding the material ejection part 41 fixed to the head 31, signals for controlling the material ejection amount from the material ejection part 41 and so on are generated in a material feed controller 62 based on control signals from the control unit 60, and a predetermined amount of material is ejected from the material ejection part 41 in accordance with the signal thus generated.

To the material ejection part 41, a feed tube 42a as a material feed path extends from the material feed unit 42 provided to the material feed device 40, and is connected.

In the material feed unit 42, a sintering target material including the raw material of the three-dimensionally shaped article 200 to be shaped by the three-dimensionally shaping device 1000 according to the present embodiment is housed as the feed material. As the sintering target material of the feed material, there is used a slurry (or paste) mixture material obtained by kneading simple-substance powder of metal to be the raw material of the three-dimensionally shaped article 200 such as magnesium (Mg), iron (Fe), cobalt (Co), chromium (Cr), aluminum (Al), titanium (Ti), or nickel (Ni), or mixture powder of an alloy or the like including one or more of these metals, a solvent, and a binder with each other.

It should be noted that the metal powder preferably has the average particle diameter of 10 μm or smaller, and as the solvent or the dispersion medium, in addition to a variety of types of water such as distilled water, purified water, or RO water, there can be cited, for example, alcohols such as methanol, ethanol, 2-propanol, 1-butanol, 2-butanol, octanol, ethylene glycol, diethylene glycol, or glycerine, ethers (cellosolve™) such as ethylene glycol monomethyl ether (methyl cellosolve), ethylene glycol monoethyl ether (ethyl cellosolve), or ethylene glycol monophenyl ether (phenyl cellosolve), esters such as methyl acetate, ethyl acetate, butyl acetate, or ethyl formate, ketones such as acetone, methyl ethyl ketone, diethyl ketone, methyl isobutyl ketone, methyl isopropyl ketone, or cyclohexanon, aliphatic hydrocarbons such as pentane, hexane, or octane, cyclic hydrocarbons such as cyclohexane or methyl cyclohexane, aromatic hydrocarbons having a long-chain alkyl group and a benzene ring such as benzene, toluene, xylene, hexylbenzene, heptylbenzene, octylbenzene, nonylbenzene, decylbenzene, undecylbenzene, dodecylbenzene, tridecylbenzene, or tetradecylbenzene, halogenated hydrocarbons such as methylene chloride, chloroform, carbon tetrachloride, or 1,2-dichloroethane, aromatic heterocyclic compounds such as pyridine, pyrazine, furan, pyrrole, thiophene or methylpyrrolidone, nitriles such as acetonitrile, propionitrile, or acrylonitrile, amides such as N,N-dimethylformamide or N,N-dimethylacetamide, carboxylate, and other variety of oils.

The thickening agent is not particularly limited providing the thickening agent is soluble in the solvent or the dispersion medium described above. For example, acrylic resin, epoxy resin, silicone resin, cellulosic resin, synthetic resin can be used. Further, thermoplastic resin such as PLA (polylactate), PA (polyamide), PPS (polyphenylene sulfide) can also be used. In the case of using the thermoplastic resin, the flexibility of the thermoplastic resin is kept by heating the material ejection part 41 and the material feed unit 42. Further, by using silicone oil or the like as a heat-resistant solvent, the flow property can be improved.

In the laser irradiation part 51 provided to the laser irradiation device 50 fixed to the head 31, a laser with a predetermined output power is excited by a laser oscillator 52 based on the control signal from the control unit 60, and then the laser is emitted from the laser irradiation part 51. The laser is applied to the feed material having been ejected from the material ejection part 41 to sinter, or melt and then solidify the metal powder included in the feed material. On this occasion, the solvent and the thickening agent included in the feed material are evaporated or thermally decomposed by the heat of the laser at the same time. The laser used in the three-dimensionally shaping device 1000 according to the present embodiment is not particularly limited, but is more preferably a fiber laser high in absorption efficiency of metal than a carbon dioxide gas laser.

In the three-dimensionally shaping device 1000 according to the present embodiment, there is adopted a configuration of applying the laser as an energy beam. Since the output power control is easy, and the irradiation target can accurately be irradiated, it is preferable to use the laser. It should be noted that the configuration of applying the laser as the energy beam is not a limitation. A high-frequency wave, a halogen lamp, or the like can also be adopted providing those are the devices for supplying the sufficient amount of heat to sinter the sintering target material.

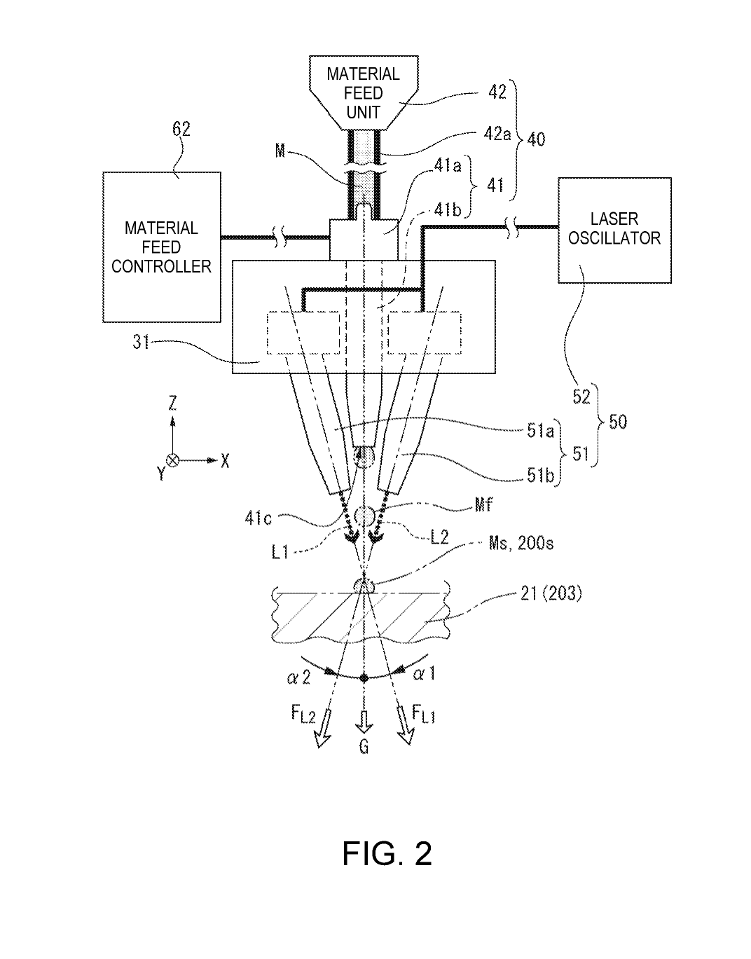

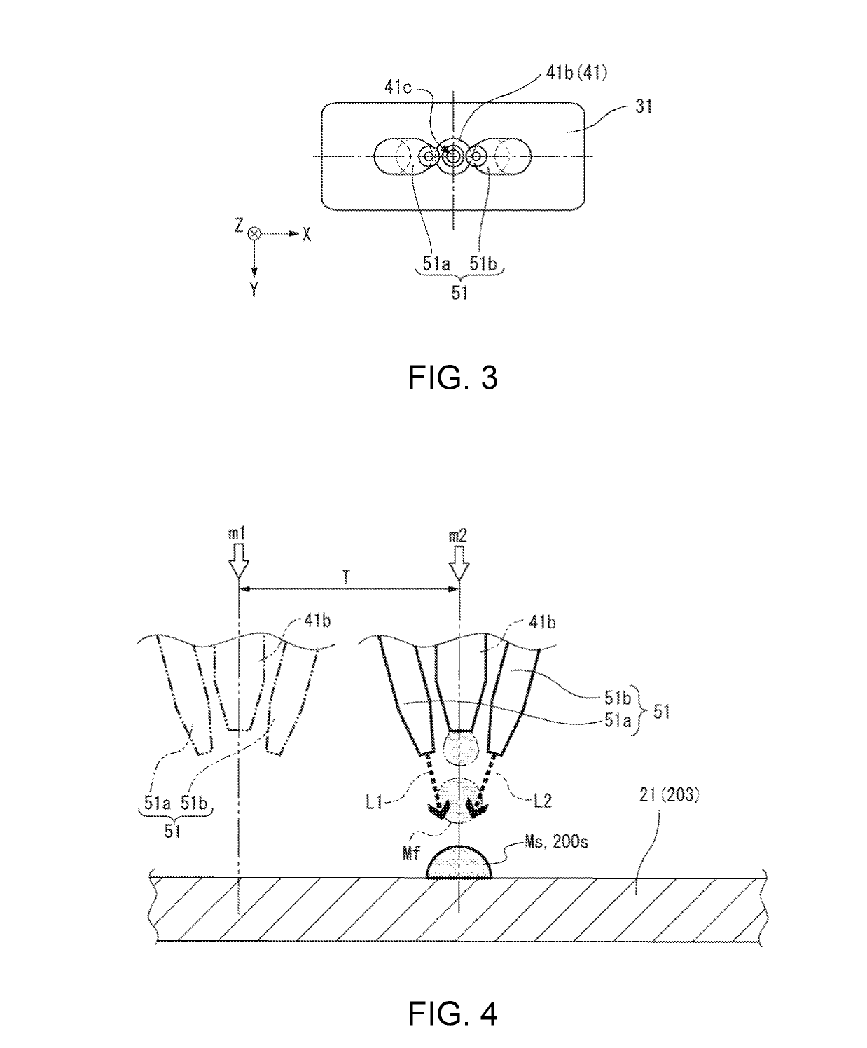

FIGS. 2 and 3 are enlarged external views showing the head 31 shown in FIG. 1, and the material ejection part 41 and the laser irradiation part 51 held by the head 31, wherein FIG. 2 is an external view viewed along the Y-direction arrow shown in FIG. 1, and FIG. 3 is an external view viewed along the Z-direction arrow shown in FIG. 1. As shown in FIGS. 2 and 3, the material ejection part 41 held by the head 31 is provided with an ejection nozzle 41b, and an ejection drive part 41a for ejecting a predetermined amount of material from the ejection nozzle 41b. To the ejection drive part 41a, there is connected a feed tube 42a connected to the material feed unit 42, and the sintering target material M is fed via the feed tube 42a. The ejection drive part 41a is provided with an ejection drive device not shown, and feeds out the sintering target material M to the ejection nozzle 41b based on the control signal from the material feed controller 62.

The sintering target material M having been ejected from an ejection hole 41c of the ejection nozzle 41b forms a material flying body Mf having a droplet shape, namely a roughly spherical shape, and flies toward the sample plate 21 or the partial shaped article 203 on the upper layer shown in FIG. 1, and then lands on the sample plate 21 or the partial shaped article 203, and is formed on the sample plate 21 or the partial shaped article 203 as a unit material Ms.

Then, toward the unit material Ms, a laser L1 is emitted from a first laser irradiation part 51a, and a laser L2 is emitted from a second laser irradiation part 51b. The unit material Ms is heated and sintered by the laser L1 and the laser L2.

It is preferable for the material flying body Mf ejected from the ejection hole 41c to be ejected from the ejection hole 41c toward gravitational direction G of the arrow shown in the drawing. That is, by ejecting the material flying body Mf in the gravitational direction G, it becomes possible to make the material flying body Mf surely fly toward the landing position to thereby dispose the unit material Ms at the desired position. Further, regarding the lasers L1, L2 emitted toward the unit material Ms having been ejected toward the gravitational direction G and then landed, the laser L1 is emitted from the first laser irradiation part 51a toward a direction crossing the gravitational direction G, namely the irradiation direction F_{L1} shown in the drawing and having an angle α1 with the gravitational direction G, and is applied to the unit material Ms. Similarly, the laser L2 is emitted from the second laser irradiation part 51b toward the irradiation direction F_{L2} shown in the drawing and having an angle α2 with the gravitational direction G, and is applied to the unit material Ms, and thus a sintered body 200s is formed.

As described above, in the three-dimensionally shaping device 1000, the unit material Ms is disposed on the sample plate 21 or the partial shaped article 203, and the sintered body 200s sintered by the lasers L1, L2 is formed. Then, the plurality of sintered bodies 200s is formed at predetermined positions based on the shaping data of the three-dimensionally shaped article 200 while the stage 20 and the head 31 are relatively driven in the X, Y, and Z directions by the drive device 11 provided to the base 10 to thereby form the partial shaped articles 201, 202, and 203 as sintered single layers as aggregates of the sintered bodies 200s.

FIGS. 4, 5, and 6 schematically show the configuration of forming the sintered body 200s constituting the sintered single layer of the three-dimensionally shaped article formed using the three-dimensionally shaping device 1000 described above. In the configuration shown in FIG. 4, the head 31 (see FIG. 1) is moved from a standby state at a standby position m1 to a formation position m2, at which the sintered body 200s starts to be formed, as much as a distance T, and the ejection nozzle 41b of the material ejection part 41 is placed at the formation position m2.

Then, the material flying body Mf having been ejected from the ejection nozzle 41b lands on the sample plate 21 or the partial shaped article 203, and is formed on the sample plate 21 or the partial shaped article 203 as the unit material Ms. The lasers L1, L2 are emitted from the laser irradiation parts 51a, 51b toward the unit material Ms thus formed to form the sintered body 200s.

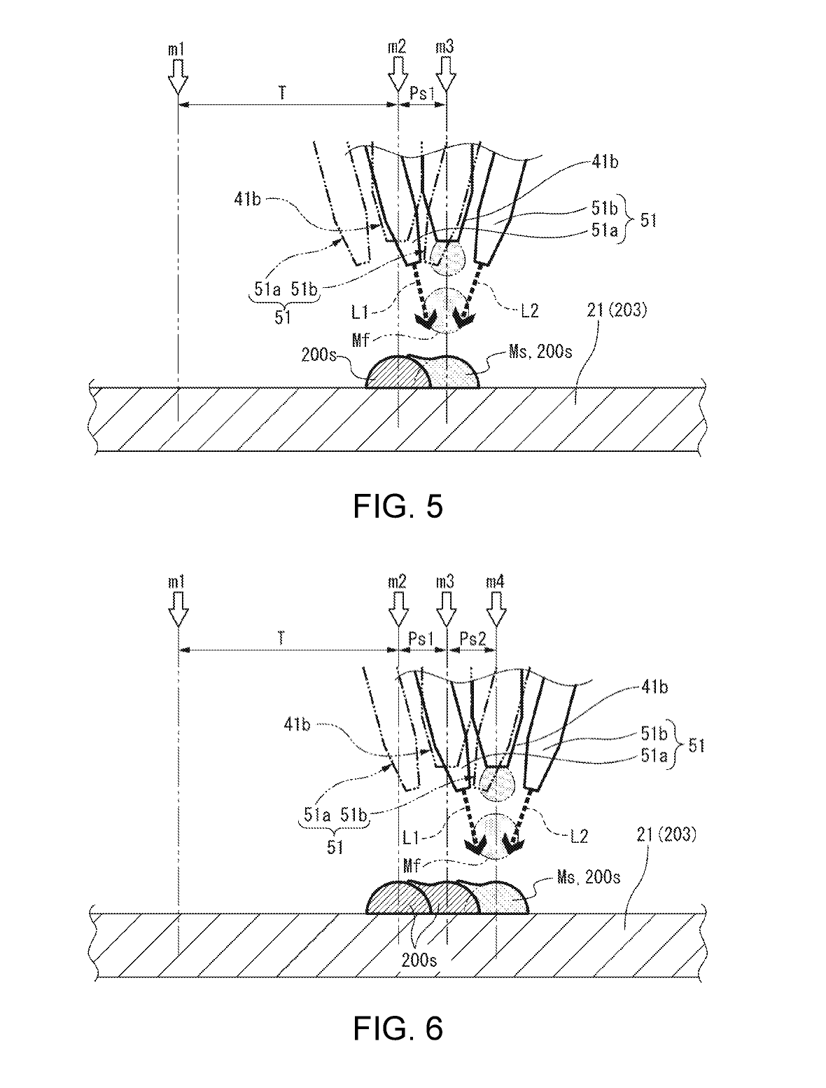

When the sintered body 200s is formed at the formation position m2, the head 31 is moved to the next formation position m3 shown in FIG. 5 as much as a distance Ps1 to place the ejection nozzle 41b of the material ejection part 41 at the formation position m3. Then, the material flying body Mf having been ejected from the ejection nozzle 41b lands on the sample plate 21 or the partial shaped article 203, and is formed on the sample plate 21 or the partial shaped article 203 as the unit material Ms. The lasers L1, L2 are emitted from the laser irradiation parts 51a, 51b toward the unit material Ms thus formed to form the sintered body 200s at the formation position m3.

When the sintered body 200s is formed at the formation position m3, the head 31 is further moved to the next formation position m4 shown in FIG. 6 as much as a distance Ps2 to place the ejection nozzle 41b of the material ejection part 41 at the formation position m4. Then, the material flying body Mf having been ejected from the ejection nozzle 41b lands on the sample plate 21 or the partial shaped article 203, and is formed on the sample plate 21 or the partial shaped article 203 as the unit material Ms. The lasers L1, L2 are emitted from the laser irradiation parts 51a, 51b toward the unit material Ms thus formed to form the sintered body 200s at the formation position m4.

As described above, the single layers constituting the three-dimensionally shaped article 200 according to the present embodiment are respectively formed of the partial shaped articles 201, 202, and 203 as the sintered single layers of the aggregates of the sintered bodies 200s formed by moving the head 31, namely the material ejection part 41 and the laser irradiation part 51 provided to the head 31, to dispose the unit materials Ms at the formation positions m2, m3, and m4 shown in FIGS. 4, 5, and 6, and then irradiating the unit materials Ms with the lasers L1, L2.

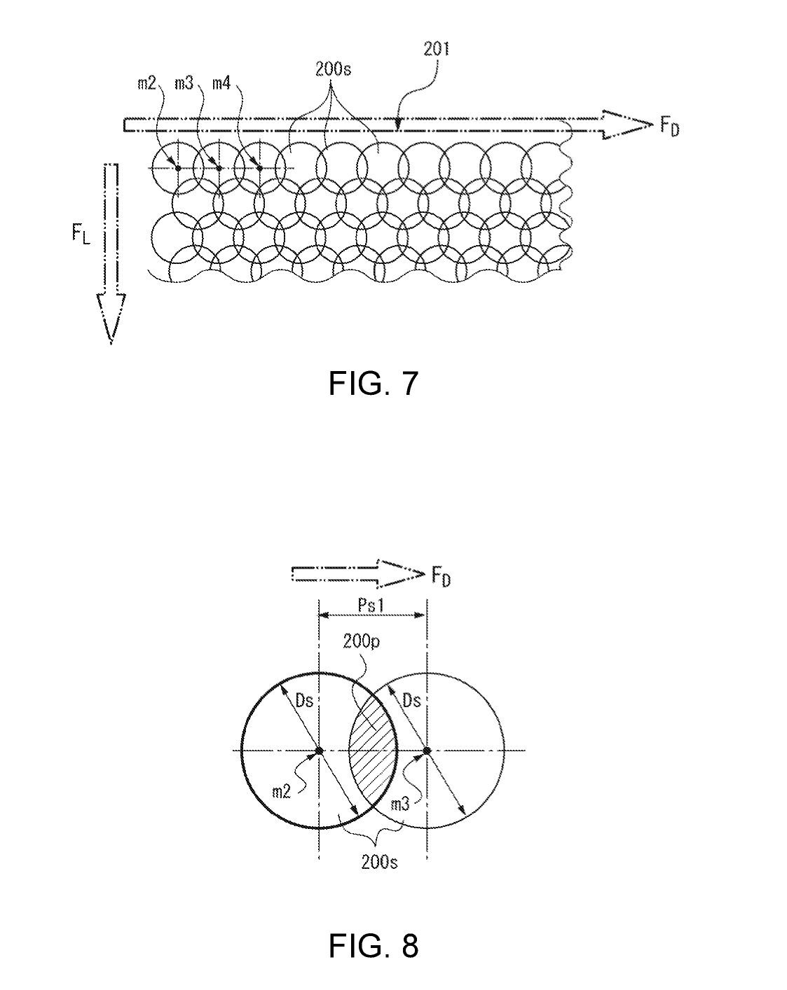

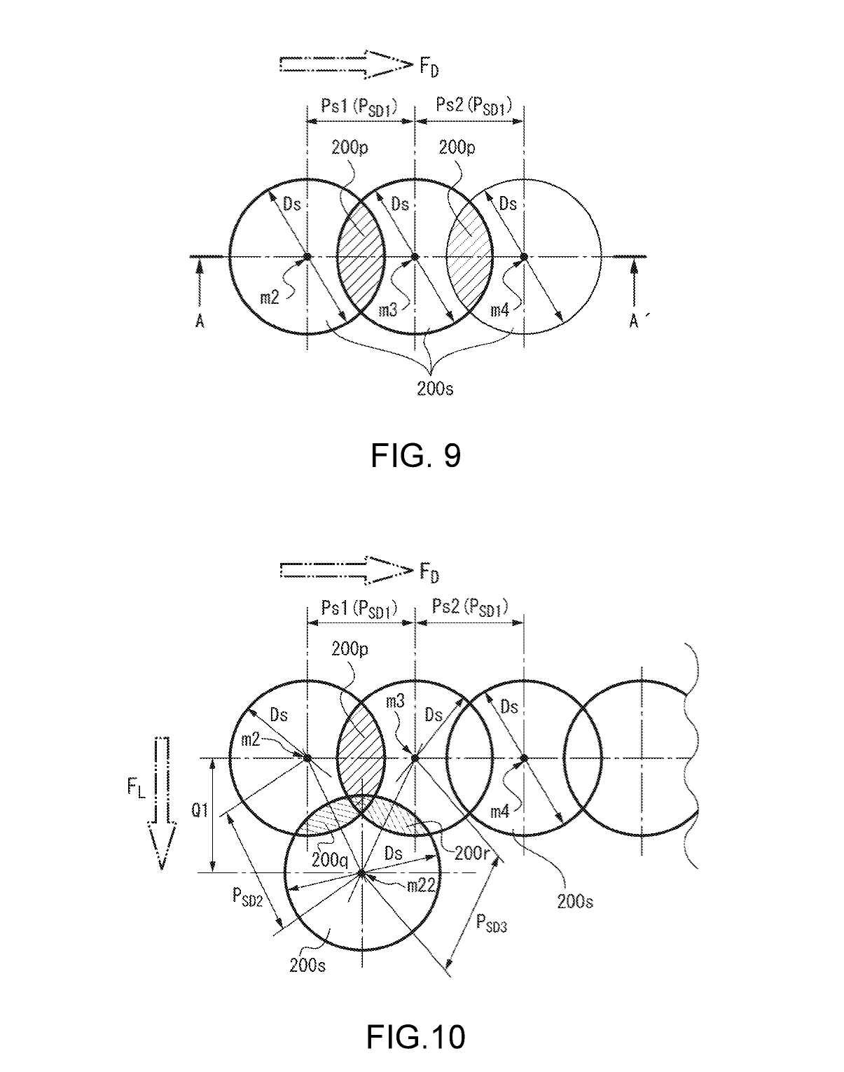

FIGS. 7, 8, and 9 are conceptual diagrams for explaining the arrangement of the sintered bodies 200s in each of the partial shaped articles 201, 202, and 203 explained with reference to FIGS. 4, 5, and 6. It should be noted that for the sake of convenience of explanation, the description is presented using the partial shaped article 201 as an example, and FIG. 7 is a conceptual diagram for explaining a scanning configuration of the head 31, namely the scanning configuration of the material ejection part 41, and FIGS. 8 and 9 are conceptual diagrams for explaining the detailed arrangement of the sintered bodies 200s illustrating the sintered bodies 200s formed at the formation positions m2, m3, and m4 shown in FIGS. 4, 5, and 6. It should be noted that although described later, since a second single layer is stacked on a first single layer to form the three-dimensionally shaped article, the “first single layer” and the “second single layer” in the following description are the expressions for classifying a so-called vertical relationship between the single layers stacked one another, and the lower layer is defined as the first single layer and the upper layer is defined as the second single layer.

As shown in FIG. 7, in the present embodiment, there is illustrated the scanning configuration of the head 31 in which the head 31 is moved in the F_{L} direction when the formation of the sintered bodies 200s in the predetermined area in the F_{D} direction is completed while sequentially forming the sintered bodies 200s by moving the head 31 in the F_{D} direction of the arrow shown in the drawing and ejecting the material from the material ejection part 41 to form the unit materials Ms on the sample plate 21 and then irradiating the unit materials Ms with the lasers L1, L2, and then the sintered bodies 200s are formed in a predetermined area in the F_{D} direction. By performing the scan with the head 31 in such a manner, the partial shaped article 201 as the sintered single layer of the aggregate of the sintered bodies 200s is formed.

The sintered bodies 200s formed by the scan with the head 31 shown in FIG. 7 are arranged as shown in FIGS. 8 and 9. As shown in FIG. 8, the sintered body 200s is formed at the formation position m3 so as to be adjacent to the sintered body 200s having been formed at the formation position m2. The sintered body 200s at the formation position m2 and the sintered body 200s at the formation position m3 are formed so as to have the distance Ps1 explained with reference to FIG. 5. Hereinafter, the distance Ps1 is referred to as a dot pitch Ps1.

The dot pitch Ps1 is determined so as not to cause a non-shaped part of the sintered body 200s between the sintered body 200s at the formation position m2 and the sintered body 200s at the formation position m3, and an overlapping part 200p is formed therebetween. In other words, it is preferable to be arranged so as to fulfill the condition of Ps1<Ds with respect to the formation diameter of the sintered body 200s, namely the sintered body diameter Ds.

FIG. 9 shows the arrangement of the sintered bodies 200s formed at the formation position m3 shown in FIG. 8 and the formation position m4 adjacent to each other. The sintered body 200s at the formation position m3 and the sintered body 200s at the formation position m4 are formed so as to have the distance Ps2 explained with reference to FIG. 6. Hereinafter, the distance Ps2 is referred to as a dot pitch Ps2. The dot pitch Ps2 is determined so as not to cause a non-shaped part of the sintered body 200s between the sintered body 200s at the formation position m3 and the sintered body 200s at the formation position m4, and the overlapping part 200p is formed therebetween. In other words, it is preferable to be arranged so as to fulfill the condition of Ps2<Ds with respect to the formation diameter Ds of the sintered body 200s.

As described above, it is preferable to control the scan with the head 31 so that the sintered bodies 200s formed in the scanning direction F_{D} shown in FIG. 7 are arranged so as to fulfill the condition of P_{SD1}<Ds denoting the dot pitch of the sintered bodies 200s adjacent to each other by P_{SD}. Furthermore, it is preferable to fulfill P_{SD1}≧Ds/2 in order to widen the sintered area formed by the sintered bodies 200s adjacent to each other. Therefore, it is more preferable to fulfill the condition of 0.5≦P_{SD1}/Ds<1.0.

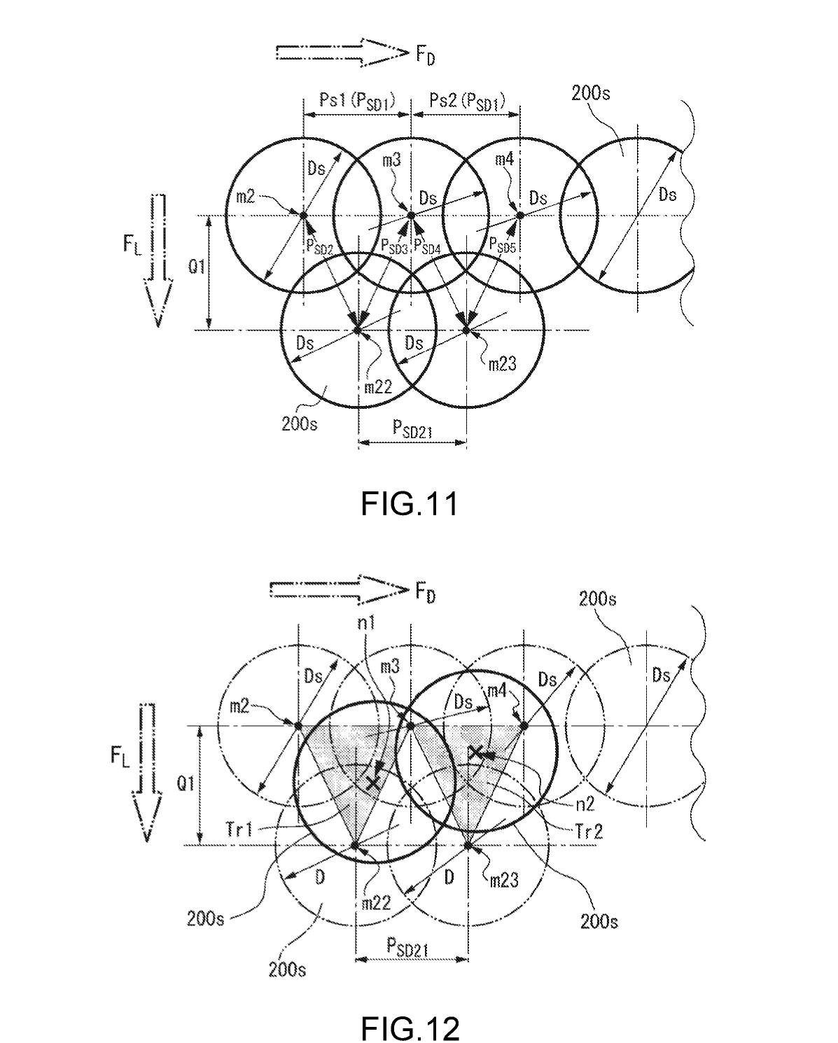

FIGS. 10 and 11 are conceptual diagrams for explaining the arrangement of the sintered bodies in the case of forming the sintered bodies 200s in the second line by displacing the head 31 as much as a line pitch Q1 along the scanning direction F_{L} with respect to the sintered bodies 200s in the first line formed along the scanning direction F_{D} shown in FIGS. 8 and 9.

As shown in FIG. 10, the dot pitch P_{SD2} as the center-to-center distance between the sintered body 200s formed at the formation position m2 in the first line and the sintered body 200s formed at the formation position m22 in the second line, which is adjacent to the sintered body 200s formed at the formation position m2 in the first line, fulfills P_{SD2}<Ds, and preferably fulfills P_{SD2}≧Ds/2 similarly to the relationship between the sintered bodies 200s adjacent to each other in the first line described above. Therefore, it is preferable to fulfill 0.5≦P_{SD2}/Ds<1.0.

Further, the dot pitch P_{SD3} as the center-to-center distance between the sintered body 200s formed at the formation position m3 adjacent to the formation position m2 in the first line and the sintered body 200s formed at the formation position m22 in the second line, which is adjacent to the sintered body 200s formed at the formation position m3 in the first line, fulfills P_{SD3}<Ds, and preferably fulfills P_{SD3}≧Ds/2 similarly to the relationship between the sintered bodies 200s adjacent to each other in the first line described above. Therefore, it is preferable to fulfill 0.5≦P_{SD3}/Ds<1.0.

As described above, defining each of the dot pitches P_{SD1}, P_{SD2}, and P_{SD3} of the sintered bodies 200s formed at the formation positions m2, m3, and m22, namely the sintered bodies 200s adjacent to each other as the dot pitch Ps as the distance between the sintered body centers of the sintered bodies 200s adjacent to each other, Ps<Ds is fulfilled, and Ps≧Ds/2 is preferably fulfilled. Therefore, it is preferable to fulfill 0.5≦Ps/Ds<1.0. According to such a relationship, it is possible for the sintered bodies 200s respectively centered on the formation positions m2, m3, and m22 to have the overlapping parts 200p, 200q, and 200r.

FIG. 11 shows a configuration in which the sintered body 200s is formed at the formation position m23 so as to be adjacent to the sintered body 200s having been formed at the formation position m22 in the second line. As shown in FIG. 11, the sintered body 200s to be formed at the formation position m23 is formed at a position adjacent to the sintered bodies 200s formed at the formation position m3 and the formation position m22. Further, the sintered body 200s to be formed at the formation position m23 is formed at a position adjacent to the sintered bodies 200s formed at the formation position m3 and the formation position m4.

Defining the center-to-center distance between the formation position m23 and the formation position m3 as a dot pitch P_{SD4}, the center-to-center distance between the formation position m4 and the formation position m23 as a dot pitch P_{SD5}, and the center-to-center distance between the formation position m23 and the formation position m22 as a dot pitch P_{SD21}, the respective dot pitches fulfill the conditions described above. Specifically, 0.5≦P_{SD4}/Ds<1.0, 0.5≦P_{SD5}/Ds<1.0, and 0.5≦P_{SD21}/Ds<1.0 are fulfilled. Defining each of the dot pitches P_{SD4}, P_{SD5}, and P_{SD21} of the sintered bodies 200s adjacent to each other as the dot pitch Ps as the center-to-center distance between the sintered bodies 200s adjacent to each other, the relationship of 0.5≦Ps/Ds<1.0 is fulfilled.

It is possible to obtain the partial shaped article 201 as the sintered single layer of the aggregate by forming the sintered bodies 200s while fulfilling the dot-pitch relationship described above. According to the partial shaped article 201 which can be obtained in such a manner, by approximating the dot pitch Ps closer to the diameter Ds of the sintered body 200s, namely by approximating Ps/Ds to 1.0 while fulfilling the relationship of 0.5≦Ps/Ds<1.0, the partial shaped article 201 can be formed in a short time, and thus, the productivity can be enhanced. Further, by approximating Ps/Ds to 0.5, the partial shaped article 201 as the sintered single layer having the sintered bodies 200s adjacent to each other and densely aggregated can be formed, and thus, the precision shaping is made possible.

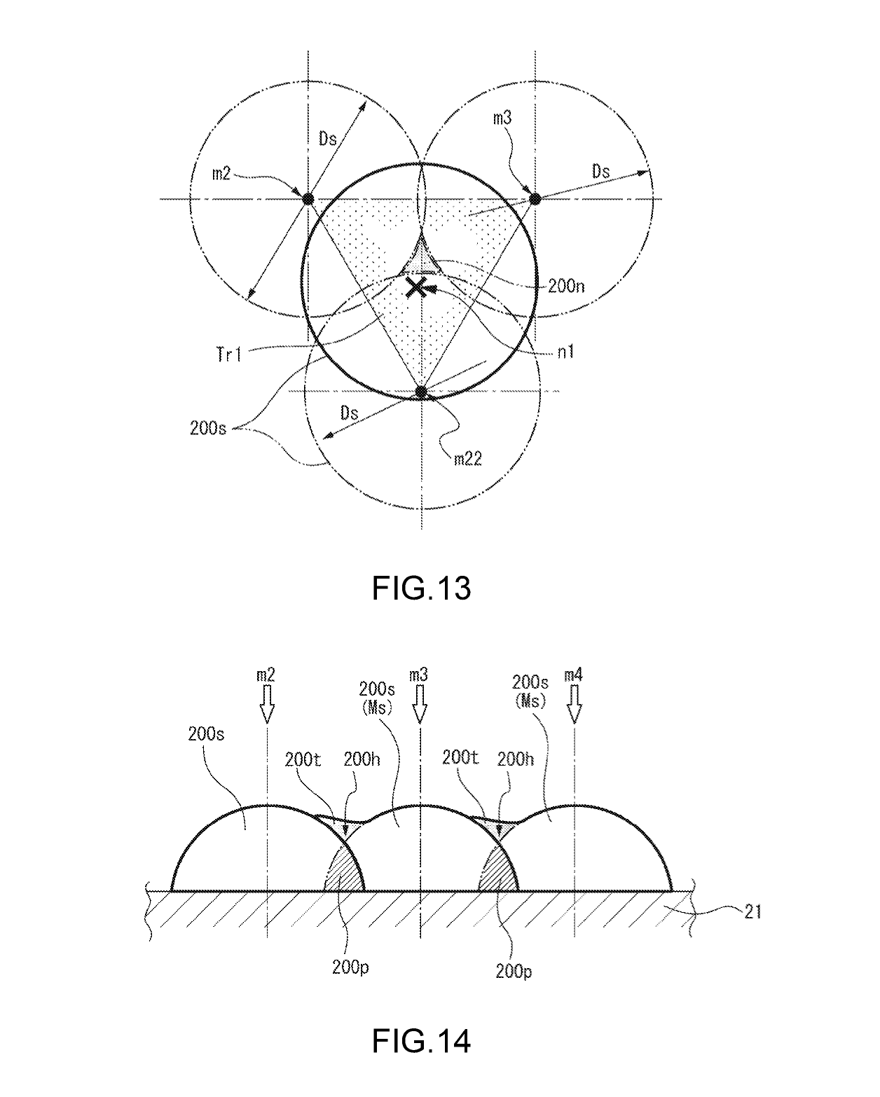

FIGS. 12 and 13 show the configuration of the sintered bodies 200s in the case of stacking the partial shaped article 202 (see FIG. 1) as the second single layer on the partial shaped article 201 as the first single layer described above. It should be noted that in FIG. 12, for the sake of convenience of explanation, the partial shaped article 201 as the first single layer is drawn with the dashed-two dotted line, and the partial shaped article 202 as the second single layer is drawn with the solid line. Further, the center of the formation position of the sintered body 200s included in the partial shaped article 201 is indicated by “•,” and the center of the formation position of the sintered body 200s included in the partial shaped article 202 is indicated by “x.”

In the case of forming the partial shaped article 202 as the second single layer shown in FIGS. 12 and 13, the sintered bodies 200s are arranged in the following manner with respect to the partial shaped article 201 as the first single layer explained using FIGS. 10 and 11. FIG. 12 illustrates two sintered bodies 200s, namely the sintered bodies 200s located at the formation position n1 and the formation position n2 as a part of the sintered bodies 200s included in the partial shaped article 202 as the second single layer. As shown in FIG. 12, the sintered body 200s formed at the formation position n1 included in the partial shaped article 202 as the second single layer is disposed so that the formation position n1 overlaps the inside of the area in the planar view of a triangular area Tr1 obtained by connecting the formation position m2 of the sintered body 200s formed at the formation position m2 as a first sintered body of the partial shaped article 201 of the lower layer, the formation position m3 of the sintered body 200s formed at the formation position m3 as a second sintered body, and the formation position m22 of the sintered body 200s formed at the formation position m22 as a third sintered body to each other.

Similarly, the sintered body 200s to be formed at the formation position n2 is disposed so that the formation position n2 overlaps the inside of the area in the planar view of a triangular area Tr2 obtained by connecting the formation position m3 of the sintered body 200s of the partial shaped article 201 of the lower layer, the formation position m4, and the formation position m23 to each other.

Further, it is preferable that the sintered bodies 200s disposed at the formation position n1 and the formation position n2, and the sintered bodies 200s not shown and included in the partial shaped article 202 are disposed so that the center-to-center distance between the formation positions, namely the dot pitch Ps as the center-to-center distance between the sintered bodies 200s adjacent to each other fulfills the relationship of 0.5≦Ps/Ds<1.0 at the same time similarly to the partial shaped article 201.

According to the sintered bodies 200s formed in the partial shaped article 202 as the second single layer in such a manner, the following advantage can be obtained. That is, if the sintered bodies 200s adjacent to each other in the partial shaped article 201 as the first single layer, namely the sintered bodies 200s formed at the formation positions m2, m3, and m22 in the present embodiment, are arranged with the dot pitch Ps having the value approximate to the value of the diameter Ds of the sintered body 200s, a non-formation part 200n of the sintered body remains between the sintered bodies 200s adjacent to each other in some cases as shown in, for example, FIG. 13. However, by disposing the sintered body 200s to be formed at the formation position n1 included in the partial shaped article 202 so that the formation position n1 overlaps the inside of the area in the planar view of the triangular area Tr1 obtained by connecting the formation position m2 of the sintered body 200s included in the partial shaped article 201 of the lower layer, the formation position m3, and the formation position m22 to each other as shown in FIG. 12 described above, the sintered body 200s is formed at the formation position n1 as shown in FIG. 13, and thus, the sintered body 200s of the partial shaped article 202 is formed so as to infill the non-formation part 200n of the sintered body. Thus, the three-dimensionally shaped article can be obtained while infilling the non-formation part, in other words, the area which can be a defective part, inside the three-dimensionally shaped article.

After stacking the partial shaped article 202 as the second single layer on the partial shaped article 201 as the first single layer described above, the partial shaped article 202 defined as the second single layer is used as the partial shaped article 202 as the new first single layer, and the partial shaped article 203 as the second single layer is formed on the partial shaped article 202 as the first single layer. By repeating the process of stacking the second single layer on the new first single layer in such a manner to sequentially form the single layers, the three-dimensionally shaped article 200 can be obtained.

As described with reference to FIGS. 8, 9, and 10, in the arrangement of the sintered body 200s, by making the relationship between the dot pitch Ps and the formation diameter Ds of the sintered body 200s fulfill 0.5≦Ps/Ds<1.0, an overlapping part 200p (the hatched part shown in the drawing) occurs between the sintered bodies 200s adjacent to each other as shown in FIG. 14, which is a cross-sectional view of the part A-A′ shown in FIG. 9.

When the unit material Ms is fed to the formation position m3 adjacent to the formation position m2 at which the sintered body 200s is formed, a part corresponding to the overlapping part 200p of the unit material Ms fed to the formation position m3 forms a run-on part 200t so as to run on the sintered body 200s formed at the formation position m2, and the sintered body 200s at the formation position m3 is formed so as to fill a recess 200h formed by the sintered bodies 200s adjacent to each other with the run-on part 200t.

Further, in the sintered body 200s to be formed at the formation position m4, the sintered body 200s at the formation position m4 is also formed so as to fill the recess 200h formed by the sintered bodies 200s formed at the formation position m3 and the formation position m4 with the run-on part 200t similarly to the case described above. By filling the recess 200h with the run-on part 200t as described above, it is possible to form the upper surface of the partial shaped article 201 as the aggregate of the sintered bodies 200s to be a smoother surface.

In the present embodiment, there is presented the explanation with the example using the two laser beams, namely the laser L1 and the laser L2, but it is also possible to adopt a configuration using the laser L1 alone. Further, regarding the laser irradiation, there can be adopted a system of performing the irradiation in a different arrangement and at different timings. Further, the laser irradiation can be pulsed irradiation or continuous irradiation.

### Second Embodiment

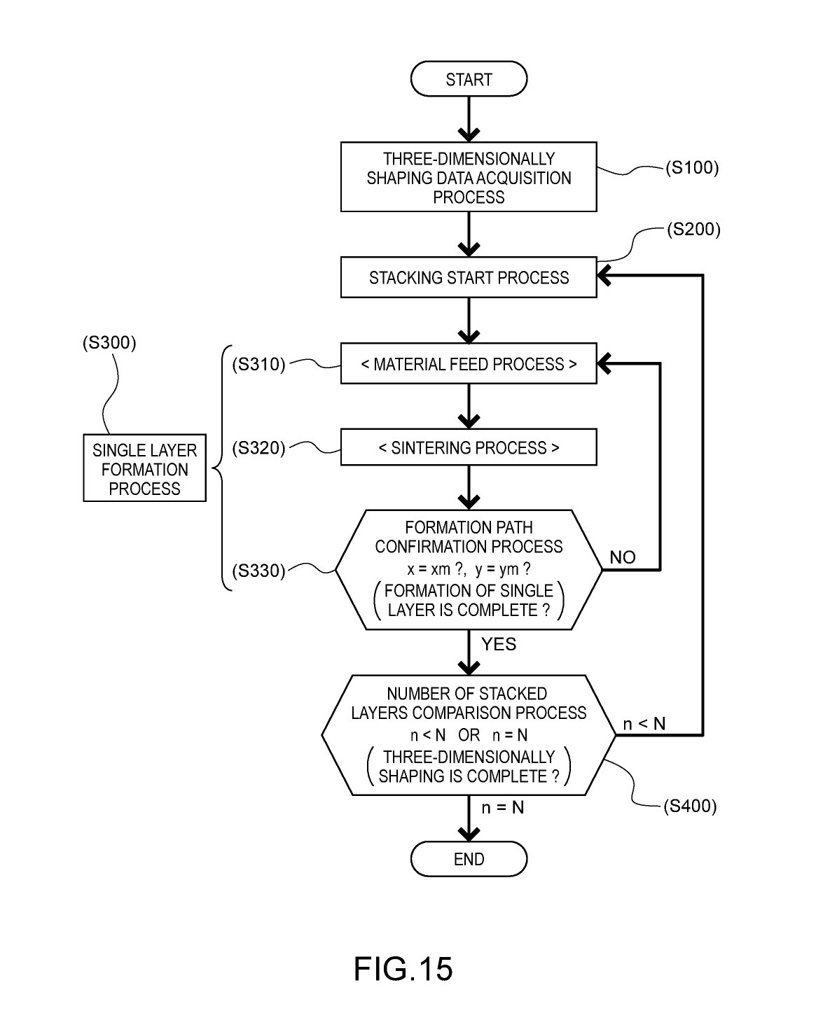

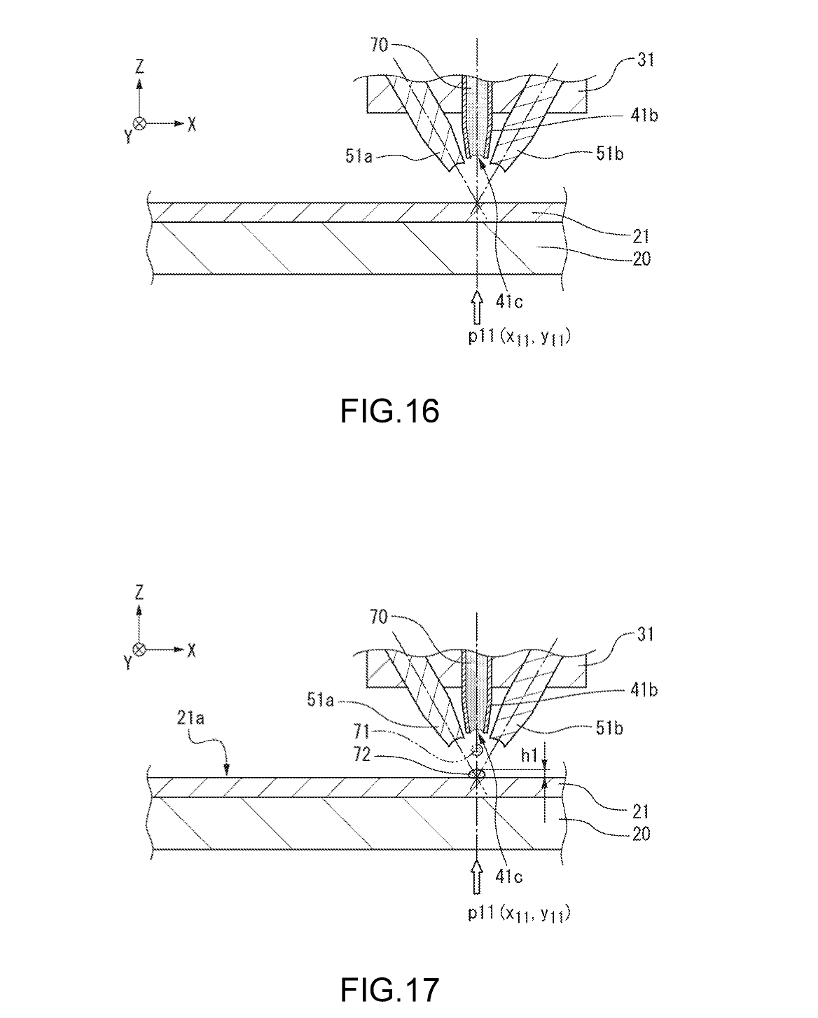

A three-dimensionally shaping method according to the second embodiment is a method of forming the three-dimensionally shaped article 200 according to the first embodiment described above. FIG. 15 shows a flowchart showing the method of manufacturing the three-dimensionally shaped article 200 according to the second embodiment, and FIGS. 16, 17, 18, and 19 each show the manufacturing method in each of the processes of the flowchart shown in FIG. 15. It should be noted that the same constituents as in the description of the three-dimensionally shaped article 200 according to the first embodiment are denoted by same reference symbols, and the explanation thereof will be omitted.

Three-Dimensionally Shaping Data Acquisition Process

As shown in FIG. 15, in the three-dimensionally shaping method according to the present embodiment, there is performed a three-dimensionally shaping data acquisition process (S100) for obtaining the three-dimensionally shaping data of the three-dimensionally shaped article 200 from, for example, a personal computer not shown to the control unit 60 (see FIG. 1). Based on the three-dimensionally shaping data obtained in the three-dimensionally shaping data acquisition process (S100), control data is transmitted from the control unit 60 to the stage controller 61, the material feed controller 62, and the laser oscillator 52, and the process proceeds to a stacking start process.

Stacking Start Process

In the stacking start process (S200), as shown in FIG. 16 showing the three-dimensionally shaping method, the head 31 is located at a predetermined relative position to the sample plate 21 mounted on the stage 20. On this occasion, the stage 20 provided with the sample plate 21 is moved so that the material flying body Mf (see FIG. 2) as the sintering target material having a droplet shape ejected from the ejection hole 41c of the ejection nozzle 41b of the material ejection part 41 lands at the coordinate position p11 (x₁₁, y₁₁) of the stage 20 as the origin of the shaping based on the three-dimensionally shaping data described above in the X-Y plane (see FIG. 1), and then the shaping of the three-dimensionally shaped article is started, and the process proceeds to a single layer formation process.

### Single Layer Formation Process

The single layer formation process (S300) includes a material feed process (S310) and a sintering process (S320) as shown in FIG. 15. Firstly, the sample plate 21 is moved so that the ejection nozzle 41b held by the head 31 is opposed to the position p11 (x₁₁, y₁₁) as the predetermined position due to the stacking start process (S200), and then the feed material 70 as the sintering target material is ejected from the ejection hole 41c of the ejection nozzle 41b as the material flying body 71 having the droplet shape toward the surface of the sample plate 21 in the gravitational direction (see FIG. 2) as the material feed process (S310) as shown in FIG. 17. As the feed material 70, there is used a material prepared by kneading the simple-substance powder of metal to be the raw material of the three-dimensionally shaped article 200 such as stainless steel or titanium alloy, or the mixture powder of a combination difficult to be alloyed such as stainless steel and copper (Cu), stainless steel and titanium alloy, or titanium alloy and cobalt (Co) or chromium (Cr), the solvent, and the binder with each other to have a slurry form (or a paste form).

The material flying body 71 lands on the upper surface 21a of the sample plate 21, and is then formed at the position p11 (x₁₁, y₁₁) on the upper surface 21a as a unit droplet material 72 (hereinafter referred to as a unit material 72) as the unit material, and thus, the material feed process (S310) is terminated. The material flying body 71 is ejected from the ejection hole 41c in the gravitational direction to fly, and thus, it is possible to make the unit material 72 accurately land at the position p11 (x₁₁, y₁₁) at which the unit material 72 should land. On this occasion, it is preferable for the sample plate 21 to be heated. If the sample plate 21 has been heated, the solvent included in the unit material 72 evaporates, and becomes lower in fluidity than the feed material 70. Therefore, the material flying body 71 is inhibited from spreading along the upper surface 21a of the sample plate 21 while wetting the upper surface 21a after landing on the upper surface 21a, and thus, the height h1 (a so-called building-up amount) of the unit material 72 from the upper surface 21a of the sample plate 21 can be ensured.

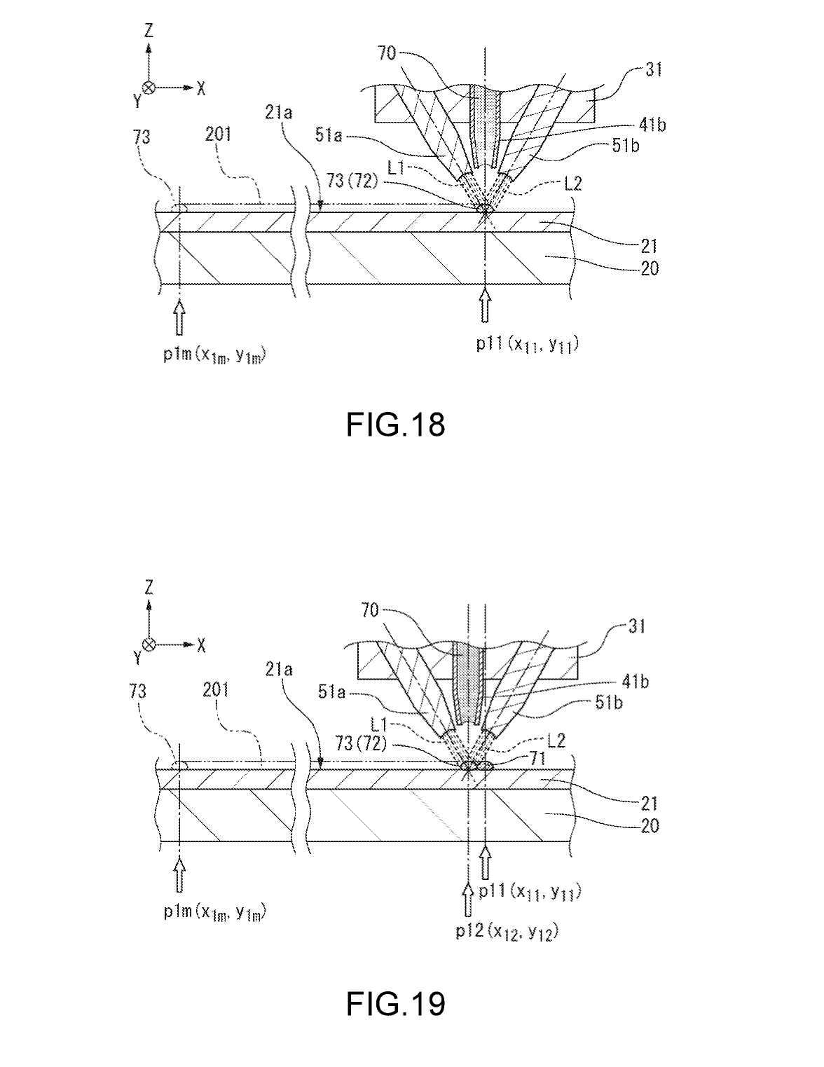

When the unit material 72 is disposed on the upper surface 21a, the sintering process (S320) is started. As shown in FIG. 18, in the sintering process (S320), the lasers L1,

L2 are emitted from the laser irradiation parts 51a, 51b toward the unit material 72 so as to cross the gravitational direction (see FIG. 2). Due to the energy (heat) which the lasers L1, L2 have, the solvent and the thickening agent included in the unit material 72 are evaporated or thermally decomposed, and the metal powder turns to the sintered body 73 of a solid metal blank due to bonding between the particles, namely so-called sintering, or fusion bonding, and is formed at the position p11 (x₁₁, y₁₁). Regarding the irradiation with the lasers L1, L2, the irradiation condition is set in accordance with the conditions of the unit material such as a material composition or the volume, the unit material 72 is irradiated with the irradiation amount thus set, and then the irradiation is stopped after the sintered body 73 is formed.

Further, although described later, the material feed process (S310) and the sintering process (S320) described above are repeated to form the partial shaped article 201 in the first layer as the first signal layer is formed in the present embodiment. In the partial shaped article 201, the material feed process (S310) described above and the sintering process (S320) are repeated m times together with the movement of the stage 20, and the sintered body 73 at the m-th trial is formed at the position of the coordinate p_{END}=p1m (x₁ₘ, y₁ₘ) of the stage 20 corresponding to the end part of the partial shaped article 201.

Therefore, when the sintered body 73 is formed at the position p11 (x₁₁, y₁₁), there is executed a formation path confirmation process (S330) for determining whether or not the number of times of performing the material feed process (S310) and the sintering process (S320) has reached the number m of repetitions necessary to form the partial shaped article 201, namely whether or not the ejection nozzle 41b has reached the coordinate position p_{END}=p1m (x₁ₘ, y₁ₘ) of the stage 20. In the case in which it is determined in the formation path confirmation process (S330) that the number has not reached the number m of repetitions, namely the ejection nozzle 41b has not reached the coordinate position p_{END}=p1m (x₁ₘ, y₁ₘ) of the stage 20, namely “NO” is determined in the formation path confirmation process (S330), the process proceeds again to the material feed process (S310), and the stage 20 is driven so that the position p12 (x₁₂, y₁₂) as the next formation position of the unit material 72 is opposed to the ejection nozzle 41b as shown in FIG. 19. Then, when the ejection nozzle 41b corresponds to the position p12 (x₁₂, y₁₂), the material feed process (S310) and the sintering process (S320) are performed, and the sintered body 73 is formed at the position p12 (x₁₂, y₁₂).

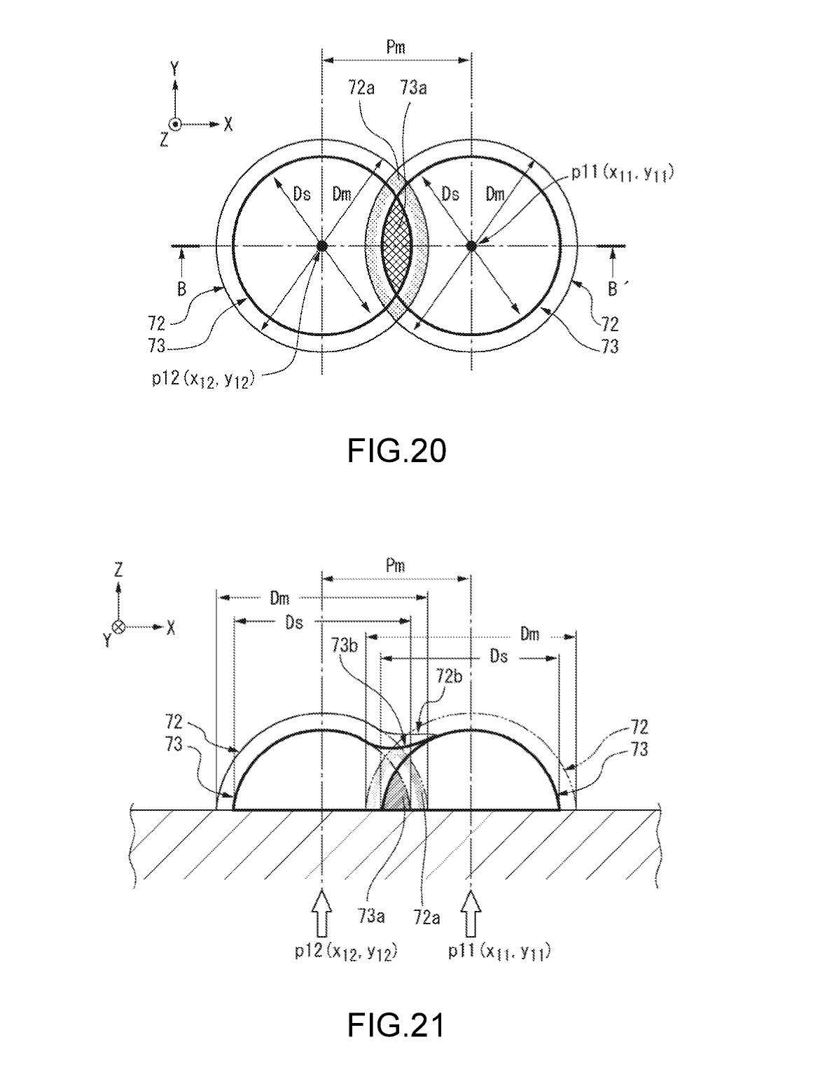

In the repeated formation of the sintered body 73, the unit materials 72 are arranged and formed as shown in FIG. 20. FIGS. 20 and 21 are diagrams for conceptually explaining the configuration of the arrangement and the formation illustrating the unit material 72 having landed at p12 (x₁₂, y₁₂) as the landing position of the adjacent unit material 72 using the position p11 (x₁₁, y₁₁), at which the unit material 72 should land, shown in FIG. 19 as the origin, wherein FIG. 20 is a planar conceptual diagram viewed in a direction from the head 31 side toward the sample plate 21 in FIG. 19, and FIG. 21 is a cross-sectional conceptual diagram of the part B-B′ shown in FIG. 20.

As shown in FIG. 20, the unit material 72 having the diameter of Dm is formed at the landing position, namely the formation position p11 (x₁₁, y₁₁) of the sintered body 73, and the sintered body 73 is formed due to the irradiation with the lasers L1, L2. By sintering the unit material 72 using the irradiation with the lasers L1, L2, contraction occurs since the binder included in the unit material 72 is thermally decomposed and then removed, and the sintered body 73 is formed to have a sintered body diameter Ds smaller than the diameter Dm (hereinafter referred to as a unit material diameter Dm) of the unit material 72.

Then, the unit material 72 is disposed and formed at the formation position p12 (x₁₂, y₁₂) adjacent to the formation position p11 (x₁₁, y₁₁), at which the sintered body 73 is formed, with the distance Pm. Hereinafter, the distance Pm is referred to as an ejection dot pitch Pm. The ejection dot pitch Pm is determined so as not to form the area, where the unit material 72 fails to be disposed, between the sintered body 73 formed at the formation position p11 (x₁₁, y₁₁) and the unit material 72 to be ejected and disposed at the formation position p12 (x₁₂, y₁₂), and to form an overlapping ejection part 72a. In other words, it is preferable for the ejection dot pitch Pm to fulfill the condition of Pm<Dm with respect to the unit material diameter Dm.

If the unit material 72 is arranged with intervals of the ejection dot pitch Pm as described above, the material of the amount corresponding to the overlapping ejection part 72a of the unit material 72 ejected at the formation position p12 (x₁₂, y₁₂) forms the run-on part 72b so as to run on the sintered body 73 formed at the formation position p11 (x₁₁, y₁₁) as shown in FIG. 21. Then, due to the sintering, the sintered body 73 formed at the formation position p12 (x₁₂, y₁₂) forms the run-on part 73b to form the sintered layer integrated with the sintered body 73 formed at the formation position p11 (x₁₁, y₁₁). Therefore, in order to prevent the non-formation part of the sintered body 73 from occurring, it is further preferable to further fulfill pm<(Dm+Ds)/2.

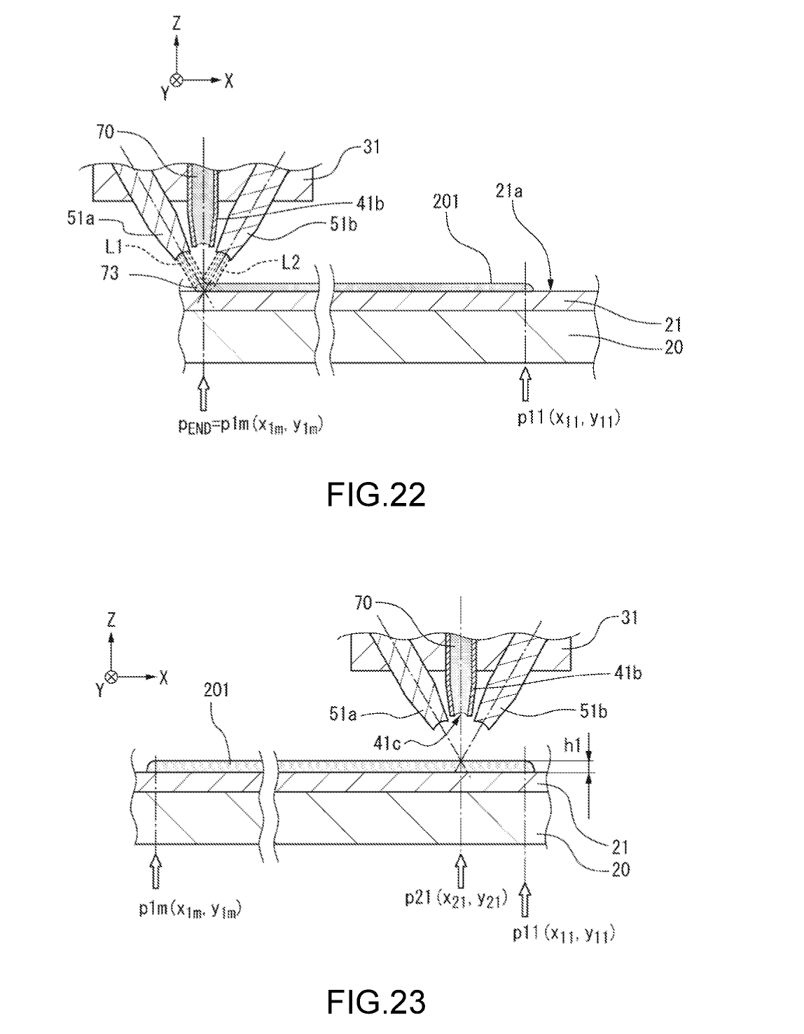

Then, as shown in FIG. 22, the material feed process (S310) and the sintering process (S320) are repeated m times to thereby form the partial shaped article 201. Then, whether or not the coordinate position of the stage 20, to which the ejection nozzle 41b is opposed, corresponding to the m-th repetition is located at the position of the coordinate of p_{END}=p1m (x₁ₘ, y₁ₘ) is checked, and if “YES” is determined, the single layer formation process (S300) is terminated.

### Number of Stacked Layers Comparison Process

When the partial shaped article 201 in the first layer as the first single layer is formed due to the single layer formation process (S300), the process proceeds to the number of stacked layers comparison process (S400) for performing the comparison with the shaping data obtained by the three-dimensionally shaping data acquisition process (S100). In the number of stacked layers comparison process (S400), the number N of the stacked layers of the partial shaped article constituting the three-dimensionally shaped article 200 and the number n of stacked layers of the partial shaped article having been stacked on and before the single layer formation process (S300) immediately before the number of stacked layers comparison process (S400) are compared with each other.

In the case in which n=N has been determined in the number of stacked layers comparison process (S400), it is determined that the formation of the three-dimensionally shaped article 200 has been completed, and the three-dimensionally shaping is terminated. However, in the case in which n<N has been determined, the stacking start process (S200) is performed again as shown in FIG. 23, which is a cross-sectional view showing the formation method of the partial shaped article 202 in the second layer as the second single layer. On this occasion, the stage 20 is moved in the Z-axis direction so as to be farther from the ejection hole 41c and the laser irradiation parts 51a, 51b as much as the thickness h1 of the partial shaped article 201 in the first layer. Further, the stage 20 provided with the sample plate 21 is moved so that the material flying body 71 (see FIG. 2; corresponding to the material flying body Mf shown in FIG. 2) as the sintering target material having a droplet shape ejected from the ejection hole 41c of the ejection nozzle 41b of the material ejection part 41 lands at the coordinate position p21 (x₂₁, y₂₁) of the stage 20 as the origin of the shaping based on the three-dimensionally shaping data, and then the formation of the second layer of the three-dimensionally shaped article is started, and the process proceeds to the single layer formation process (S300) for the second layer.

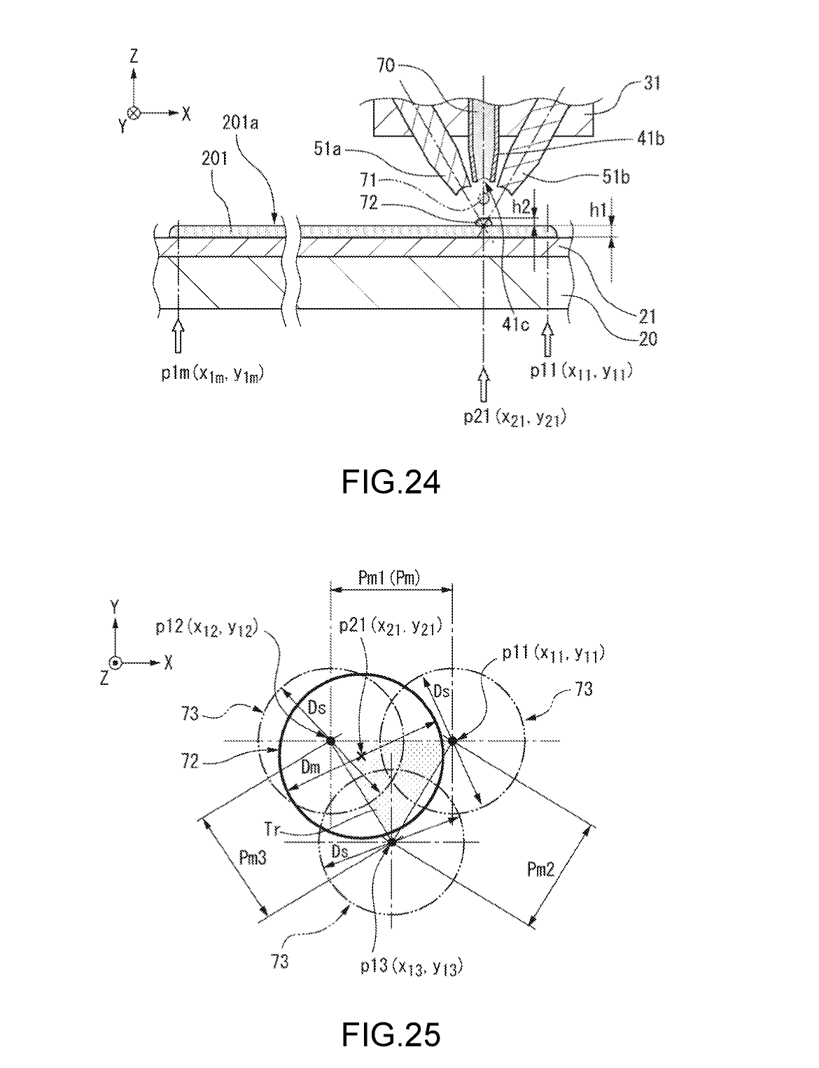

Thereafter, the single layer formation process (S300) is performed similarly to FIGS. 16, 17, 18, 19, and 22 showing the formation of the partial shaped article 201 in the first layer described above. Firstly, the sample plate 21 is moved due to the movement of the stage 20 so that the ejection nozzle 41b held by the head 31 is opposed to the position p21 (x₂₁, y₂₁) as the predetermined position due to the stacking start process (S200), and then the feed material 70 as the sintering target material is ejected from the ejection hole 41c of the ejection nozzle 41b as the material flying body 71 having the droplet shape toward an upper part 201a of the partial shaped article 201 in the first layer as the material feed process (S310) as shown in FIG. 24.

The material flying body 71 lands on the upper part 201a of the partial shaped article 201, then is disposed on the upper part 201a as the unit material 72, then the material feed process (S310) at the position p21 (x₂₁, y₂₁) is terminated, and thus, the unit material 72 with the height h2 (so-called building-up amount) is formed on the upper part 201a of the partial shaped article 201. The unit materials 72 disposed on the partial shaped article 201 are arranged as shown in FIG. 25.

FIG. 25 is a planar conceptual diagram for explaining the configuration of the arrangement and formation illustrating the state in which the unit material 72, which constitutes the partial shaped article 202 in the second layer, and should land at the position p21 (x₂₁, y₂₁) on the upper surface 201a of the partial shaped article 201 shown in FIG. 24, lands on the three sintered bodies 73 at the formation positions p11 (x₁₁, y₁₁), p12 (x₁₂, y₁₂), and p13 (x₁₃, y₁₃) adjacent to each other and constituting a part of the partial shaped article 201 in the lower layer. It should be noted that for the sake of convenience of explanation, the sintered bodies 73 constituting the partial shaped article in the first layer are drawn with the dashed-two dotted lines, and the unit material 72 forming the partial shaped article 202 in the second layer is drawn with the solid line. Further, the formation position coordinates p11 (x₁₁, y₁₁), p12 (x₁₂, y₁₂), and p13 (x₁₃, y₁₃) of the sintered bodies 73 included in the partial shaped article 201 are indicated by “•,” and the formation position coordinate p21 (x₂₁, y₂₁) of the unit material 72 forming the partial shaped article 202 is indicated by “x.”

As shown in FIG. 25, the formation position p21 (x₂₁, y₂₁) of the unit material 72 constituting the partial shaped article 202 in the second layer is disposed so as to overlap a triangular area Tr (hatched part) obtained by connecting the formation positions p11 (x₁₁, y₁₁), p12 (x₁₂, y₁₂), and p13 (x₁₃, y₁₃) of the sintered bodies 73 adjacent to each other and constituting a part of the partial shaped article 201 in the lower layer to each other. On this occasion, the respective distances Pm1, Pm2, and Pm3 between the formation positions p11 (x₁₁, y₁₁), p12 (x₁₂, y₁₂), and p13 (x₁₃, y₁₃) of the sintered bodies 73 adjacent to each other and the sintering diameter Ds of the sintered body 73 are formed so as to fulfill the conditions of Pm1<Ds, Pm2<Ds, and Pm3<Ds.

By disposing the unit material 72 constituting the partial shaped article 202 in the second layer in such a manner, even if the non-overlapping part is caused by the sintered bodies adjacent to each other formed at the formation positions p11 (x₁₁, y₁₁), p12 (x₁₂, y₁₂), and p13 (x₁₃, y₁₃) in the partial shaped article 201 in the first layer, the unit material 72 forming the partial shaped article 202 in the second layer is formed in the upper layer in an overlapping manner, and thus, it is possible to prevent the defective part such as an internal void caused by the non-formation part from occurring in the inside of the three-dimensionally shaped article 200.

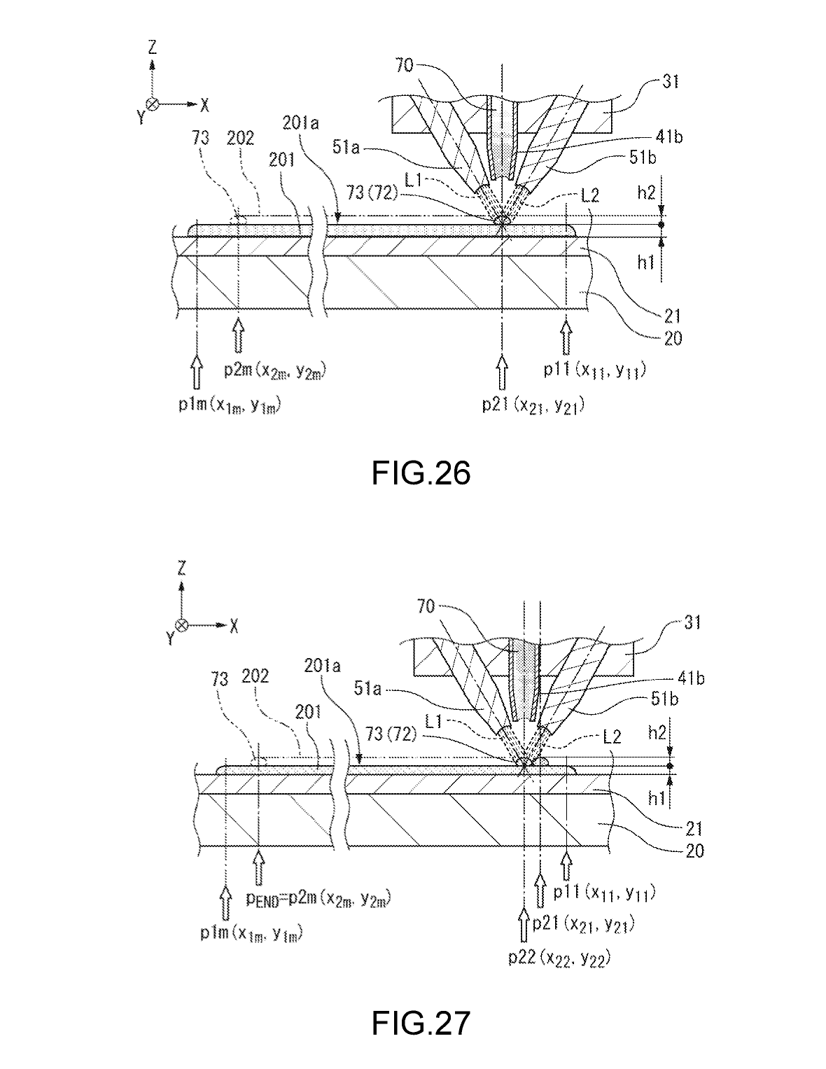

When the unit material 72 is disposed on the upper part 201a of the partial shaped article 201, the sintering process (S320) is started. As shown in FIG. 26, in the sintering process (S320), the lasers L1, L2 are emitted from the laser irradiation parts 51a, 51b toward the unit material 72, and the unit material 72 is sintered by the energy (heat) which the lasers L1, L2 have, and turns to the sintered body 73. Then, the material feed process (S310) described above and the sintering process (S320) are repeated, and the partial shaped article 202 in the second layer is formed on the upper part 201a of the partial shaped article 201 in the first layer. In the partial shaped article 202, the material feed process (S310) described above and the sintering process (S320) are repeated m times together with the movement of the stage 20, and the sintered body 73 at the m-th trial is formed at the position of the coordinate p_{END}=p2m (x₂ₘ, y₂ₘ) of the stage 20 corresponding to the end part of the partial shaped article 202.

Therefore, when the sintered body 73 is formed at the position p21 (x₂₁, y₂₁), there is executed a formation path confirmation process (S330) for determining whether or not the number of times of performing the material feed process (S310) and the sintering process (S320) has reached the number m of repetitions necessary to form the partial shaped article 202 in the second layer, namely whether or not the ejection nozzle 41b has reached the coordinate position p_{END}=p2m (x₂ₘ, y₂ₘ) of the stage 20. In the case in which it is determined in the formation path confirmation process (S330) that the number has not reached the number m of repetitions, namely the ejection nozzle 41b has not reached the coordinate position p_{END}=p2m (x₂ₘ, y₂ₘ) of the stage 20, namely “NO” is determined in the formation path confirmation process (S330), the process proceeds again to the material feed process (S310), and the stage 20 is driven so that the position p22 (x₂₂, y₂₂) as the next formation position of the unit material 72 is opposed to the ejection nozzle 41b as shown in FIG. 27. Then, when the ejection nozzle 41b corresponds to the position p22 (x₂₂, y₂₂), the material feed process (S310) and the sintering process (S320) are performed, and a unit sintered body 73 is formed at the position p22 (x₂₂, y₂₂).

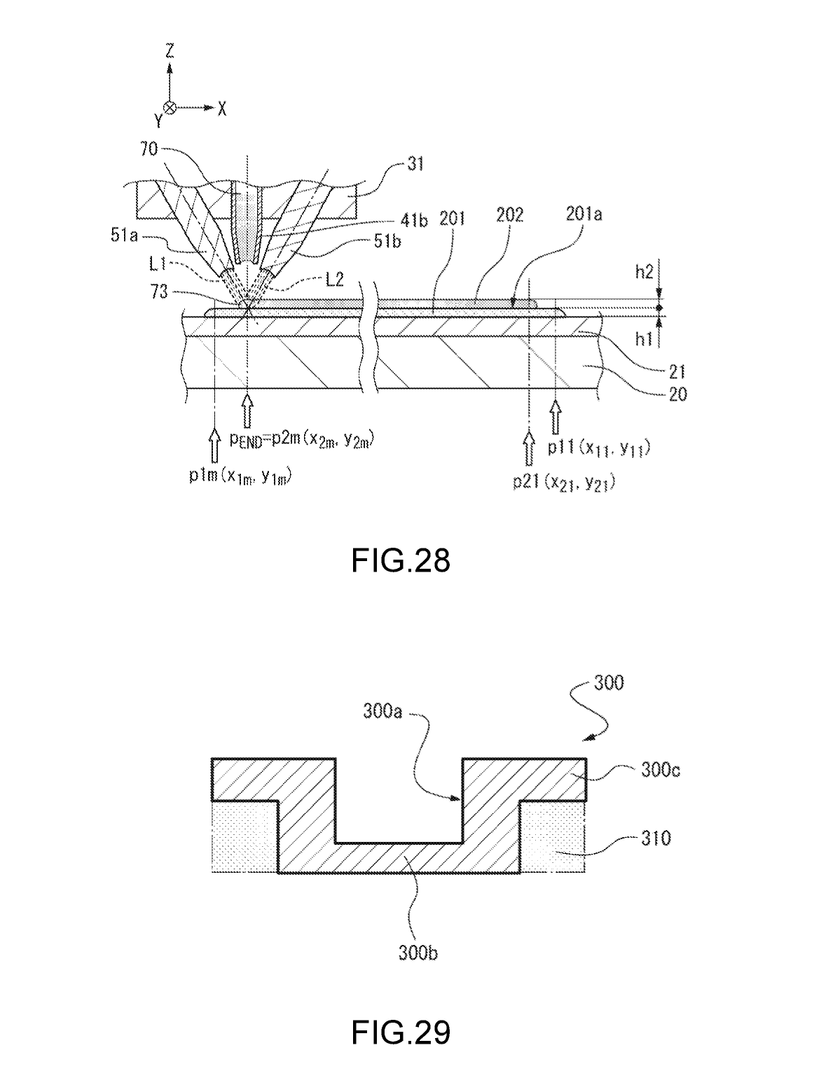

Then, as shown in FIG. 28, the material feed process (S310) and the sintering process (S320) are repeated m times to thereby form the partial shaped article 202 in the second layer. Then, whether or not the coordinate position of the stage 20, to which the ejection nozzle 41b is opposed, corresponding to the m-th repetition is located at the position of the coordinate of p_{END}=p2m (x₂ₘ, y₂ₘ) is checked, and if “YES” is determined, the single layer formation process (S300) in the second layer is terminated.

Then, the process proceeds again to the number of stacked layers comparison process (S400), the stacking start process (S200) and the single layer formation process (S300) are repeated until n=N is reached, and thus, it is possible to shape the three-dimensionally shaped article using the three-dimensionally shaping device 1000 according to the first embodiment. It should be noted that performing the stacking start process (S200) and the single layer formation process (S300) for forming the partial shaped article 202 in the second layer as the second single layer on the partial shaped article 201 in the first layer as the first single layer is referred to as a stacking process in the application examples described above, and is repeated until n=N is determined in the number of stacked layers comparison process (S400).

### Third Embodiment

The three-dimensionally shaping method according to the third embodiment will be described. In the three-dimensionally shaping method according to the second embodiment described above, in the case in which the three-dimensionally shaped article includes an overhanging part, in the overhanging part, since the partial shaped article in the lower layer, on which the material flying body 71 should land, does not exist, the unit material 72 becomes not to be formed in the material feed process (S310) in the single layer formation process (S300) described above (see FIG. 24). Even if the unit material 72 is made to land so as to be connected in an overlapping manner to the unit sintered body 73 having been formed at the position p21 (x₂₁, y₂₁) shown in FIG. 27, there is a possibility that the deformation of curving toward the gravitational direction occurs unless the partial shaped article in the lower layer is disposed. This is because the unit material 72 having not been sintered is a material in a flexible state having a slurry form (or a paste form) obtained by kneading the simple-substance powder of metal to be the raw material such as stainless steel or titanium alloy, or the mixture powder of a combination difficult to be alloyed such as stainless steel and copper (Cu), stainless steel and titanium alloy, or titanium alloy and cobalt (Co) or chromium (Cr), the solvent, and the thickening agent with each other.

Therefore, a method of forming the three-dimensionally shaped article without deforming the overhanging part using the three-dimensionally shaping method according to the third embodiment will be described. It should be noted that the same processes as in the three-dimensionally shaping method according to the second embodiment are denoted by same reference symbols, and the explanation thereof will be omitted. Further, although the three-dimensionally shaping method according to the third embodiment will be described illustrating the three-dimensionally shaped article 300 having such a simple shape as shown in FIG. 29 in order to simplify the description, the shape is not a limitation, and the present method can be applied to any shaped articles provided with a so-called overhanging part.

As shown in FIG. 29, the three-dimensionally shaped article 300 is provided with a flange part 300c having a circular outer shape, which is the overhanging part extending outward from the base 300b, located at an end part on the opening side of the recessed part of the base 300b having a columnar shape having the recessed part 300a having a columnar shape. In order to form the three-dimensionally shaped article 300 based on the three-dimensionally shaping method according to the third embodiment, the shaping data for the support part 310, which extends in the direction toward the lower part shown in the drawing of the flange part 300c to the bottom part of the base 300b, and is removed in the formation process, is generated in addition to the three-dimensionally shaping data of the three-dimensionally shaped article 300.

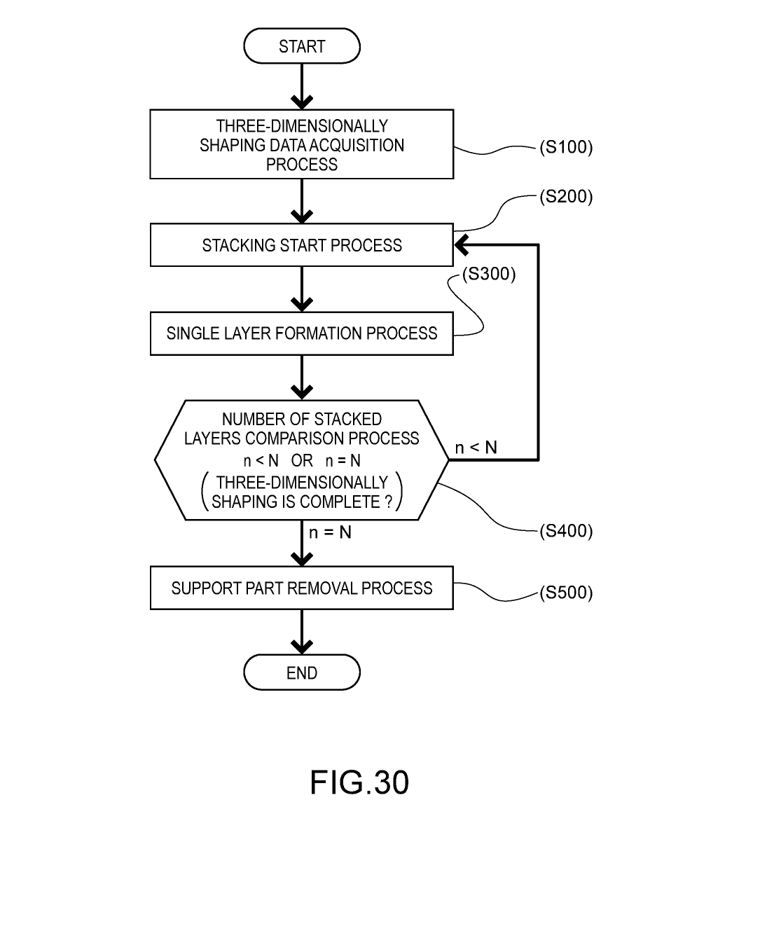

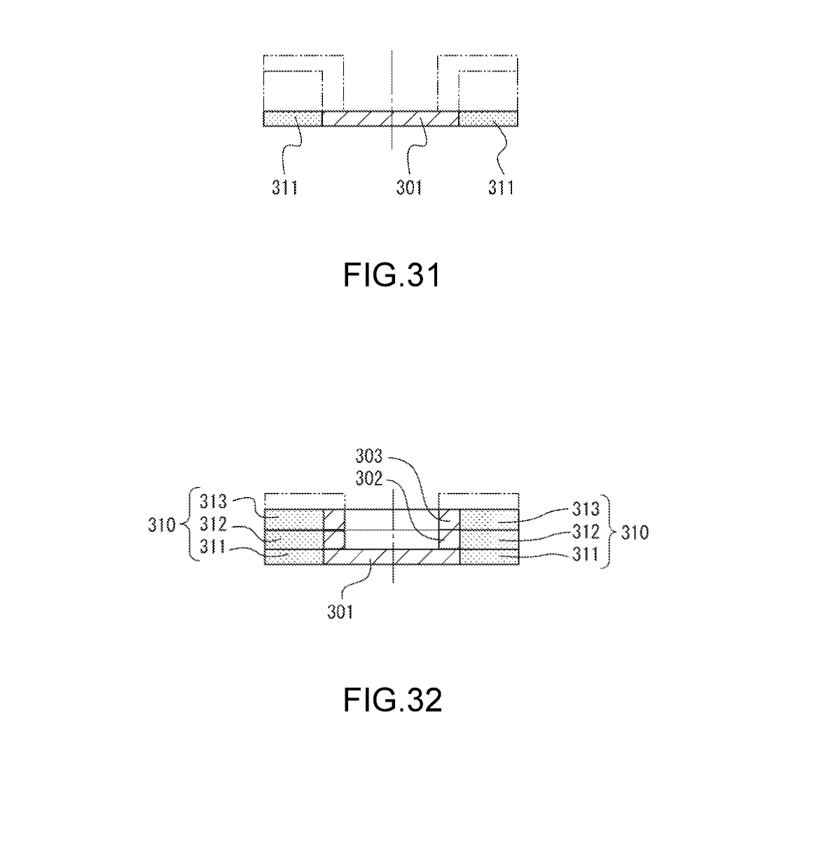

FIG. 30 is a flowchart showing a shaping method of the three-dimensionally shaped article 300 shown in FIG. 29. Further, FIGS. 31, 32, 33, and 34 are cross-sectional views showing the shaping process of the three-dimensionally shaped article 300 according to the flowchart shown in FIG. 30. Further, although in the three-dimensionally shaped article 300 according to the present embodiment, the description is presented using the example of forming the article by stacking four layers, the example is not a limitation.

Firstly, as shown in FIG. 31, the partial shaped article 301 to be the first layer is shaped on the sample plate 21 not shown using the three-dimensionally shaping method according to the second embodiment. In the process of forming the partial shaped article 301, a partial support part 311 in the first layer is also formed. The sintering process (S320) in the single layer formation process (S300) explained with reference to FIGS. 18 and 19 is not performed on the partial support part 311, and in the partial support part 311, the single layer formation process (S300) is performed while keeping the state of the unit material 72, namely an unsintered part or an unmelted part.

Subsequently, the single layer formation process (S300) is repeated, and as shown in FIG. 32, the partial shaped articles 302, 303 to be the second layer and the third layer are formed. Then, in the process of forming the partial shaped articles 302, 303, partial support parts 312, 313 in the second layer and the third layer are also formed. The sintering process (S320) in the single layer formation process (S300) is not performed on the partial support parts 312, 313 similarly to the partial support part 311, and in the partial support parts 312, 313, the single layer formation process (S300) is performed while keeping the state of the feed material 70, namely an unsintered part or an unmelted part, and the support part 310 is formed by the partial support parts 311, 312, and 313.

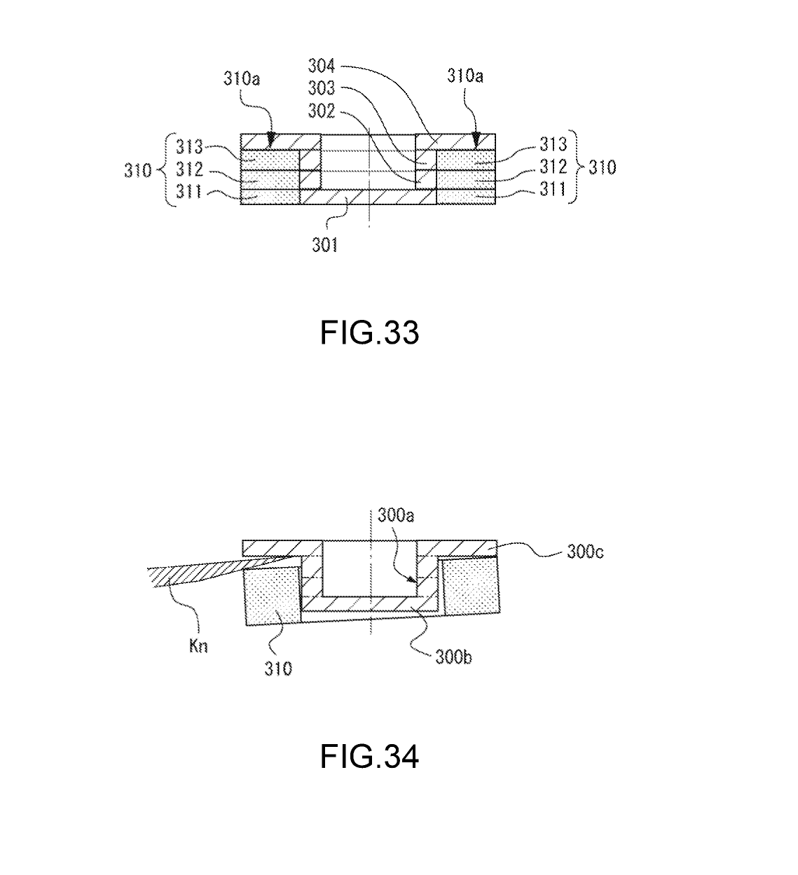

Then, as shown in FIG. 33, the partial shaped article 304 in the fourth layer, which is formed in the flange part 300c, is formed. The partial shaped article 304 is formed so as to be supported by an end surface 310a of the support part 310 formed by the partial support parts 311, 312, and 313. By forming the partial shaped article 304 in such a manner, since the end surface 310a is formed as a surface on which the unit material 72 (see FIG. 24) lands, the partial shaped article 304 in the fourth layer to be the flange part 300c can accurately be formed.

Then, as shown in FIG. 34, when shaping of the three-dimensionally shaped article 300 is completed, the support part 310 is removed from the three-dimensionally shaped article 300 in a support part removal process (S500). Since the support part 310 is formed of a material having not been sintered, as the removal method of the support part 310 in the support part removal process (S500), physical ablation with a sharp knife Kn, for example, can be adopted as shown in FIG. 34. Alternatively, it is also possible to dip the article in the solvent to resolve the thickening agent included in the material, and then remove the support part 310 from the three-dimensionally shaped article 300.

As described above, in the case of shaping the three-dimensionally shaped article having the flange part 300c as the overhanging part, by forming the support part 310 for supporting the flange part 300c together with the shaping of the three-dimensionally shaped article 300, the deformation toward the gravitational direction of the flange part 300c can be prevented. It should be noted that the support part 310 shown in FIG. 29 is not limited to the configuration of supporting the flange part 300c in the entire surface as shown in the drawing, and the shape, the size, and so on can appropriately be set in accordance with the shape of the shaped article, the material composition, and so on.

It should be noted that the specific configuration to be adopted when implementing the invention can arbitrarily be replaced with another device or method within the range in which the advantages of the invention can be achieved.

The entire disclosure of Japanese patent No. 2015-146425, filed Jul. 24, 2015 is expressly incorporated by reference herein.

What is claimed is:

1. A three-dimensionally shaped article formed by stacking a second single layer on a first single layer, the first single layer including a sintered single layer obtained by irradiating a sintering target material including a metal powder and a binder with an energy beam capable of sintering the sintering target material, and the second single layer including at least the sintered single layer, wherein
the sintered single layer is formed by aggregating sintered bodies each sintered by irradiating the sintering target material ejected to forma droplet shape with the energy beam, and
defining a sintered body diameter in a planar view of the sintered body as Ds, and a distance between sintered body centers of the sintered bodies adjacent to each other as Ps, 0.5≦Ps/Ds<1.0 is fulfilled.

2. The three-dimensionally shaped article according to claim 1, wherein
the sintered single layer includes a first sintered body, a second sintered body, and a third sintered body adjacent to each other, and
in the second single layer, the sintered body center of the sintered body included in the second single layer is disposed so as to overlap a triangular area in a planar view configured by connecting the respective sintered body centers of the first sintered body, the second sintered body, and the third sintered body included in the first single layer to each other.

3. The three-dimensionally shaped article according to claim 1, wherein
the energy beam is a laser.

4. A three-dimensionally shaping method adapted to obtain a three-dimensionally shaped article by stacking a second single layer on a first single layer, the first single layer including a sintered single layer obtained by irradiating a sintering target material including a metal powder and a binder with an energy beam capable of sintering the sintering target material, and the second single layer including at least the sintered single layer, wherein
the sintered single layer is formed by aggregating sintered bodies each sintered by irradiating a unit material formed by ejecting the sintering target material to form a droplet shape with the energy beam, and
defining a unit material diameter in a planar view of the unit material as Dm, and a distance between unit material centers of the unit materials adjacent to each other as Pm, 0.5≦Pm/Dm<1.0 is fulfilled.

5. The three-dimensionally shaping method according to claim 4, wherein
the sintered bodies included in the sintered single layer include a first sintered body, a second sintered body, and a third sintered body adjacent to each other, and
in the second single layer, the unit material center of the unit material forming the sintered body included in the second single layer overlaps a triangular area in a planar view constituted by respective sintered body centers of the first sintered body, the second sintered body, and the third sintered body included in the first single layer.

6. The three-dimensionally shaping method according to claim 4, wherein
the energy beam is a laser.
